(19) United States
(12) Patent Application Publication
(10) Pub. No.: US 2009/0051947 A1
(43) Pub. Date: Feb. 26, 2009

(54) PRINTING CONTROL APPARATUS AND METHOD

(75) Inventor: Masashi Kuroshima, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/196,579

(22) Filed: Aug. 22, 2008

(30) Foreign Application Priority Data
Aug. 24, 2007 (JP) 2007-218811

(51) Int. Cl. G06F 15/00; G06F 3/12

(52) U.S. Cl. 358/1.9; 358/1.15

(57) ABSTRACT

An information processing apparatus analyzes a print job made up of multiple records, detects record segments using the analysis results, correlates each record and the printing page corresponding to each record, and displays a list of records based thereupon. Further, upon operation instructions of printing control input as to a record in the displayed list, the information processing apparatus executes processing based on operating instructions as to an instructed record according to operation instructions.

### BACKGROUND OF THE INVENTION

1. Field of the Invention

The present invention relates to job control technology more specifically, control of jobs with print processing.

2. Description of the Related Art

In commercial printing, a request for printed articles (magazines, newspapers, catalogs, advertisements, posters, and so forth) is received from a client (customer) and the desired printed articles are created, for which compensation is paid by providing such articles to the client. Currently, large-scale printing apparatuses such as offset reproduction printers are primarily used for this.

In commercial printing, work is progressed along various processes such as receiving a manuscript, design/layout, comprehensive layout (presentation with printer output), proofing (layout correction and color correction), proof printing, mechanical creating, printing, post-processing processes, sending, and so forth. Also in recent years, marketing such as direct mail is commonly used, causing the need for variable printing which is a representative job of high-mix low-volume production to increase.

With variable printing, variable data is laid out on a template whereupon a region to insert variable data is defined, and printed. Thus, a print processing wherein a portion of the printed article is different can be realized in increments of desired output. For example, in Japanese Patent Laid-Open No. 2003-296070, a technique is proposed wherein jobs are generated in increments of records, in the case that a binding application determines that variable printing is specified and that variable job division is necessary based on the printing settings. Thus, a record is a printing unit consisting of a series of variable data to be inserted, and for example in the case of performing printing in increments of clients with variable printing, one record is configured for one client worth of variable data.

Recently, in accordance with the increased high speed and high image quality of printing apparatuses using electrophotography or printing apparatuses with using inkjet, a market has emerged called Print-on-demand (hereafter called POD) as a countermovement to the conventional printing industry. POD can perform print processing without creating a plate, and so has the advantage of being useful for variable printing as compared to conventional print processing such as offset printing.

Also, POD aims to handle a job on a short deadline with a comparatively low volume rather than a job handled with a large-scale printing apparatus such as an offset reproduction printer, without using a cumbersome apparatus or system, with a short deadline. With a growing need for PODs, digitalization is integrated as compared to the conventional printing industry, and management technologies and control technologies using a computer have become widespread.

However, with the conventional technology, the status for each print job can be displayed relating to the print jobs according to the variable printing output with the image forming apparatus and so forth, but status cannot be displayed for each record. Also, the printing sequence can be changed or pausing can be specified in increments of print jobs, but printing sequence changes, pausing, or canceling cannot be performed in increments of records.

An embodiment of the present invention provides an arrangement whereby control management can be performed in increments of records for a variable printing print job made up of multiple records.

### SUMMARY OF THE INVENTION

The information processing apparatus according to an embodiment of the present invention includes: an analysis unit configured to analyze a print job made up of a plurality of records, a processing unit configured to detect segments of a record using the analyzed print job and correspond each record with a printing page corresponding to each record, a display control unit configured to display a list of records based on the detected segments, and an operating unit configured to execute processing, upon operating instructions being input for printing control as to records in the displayed list, based on the operating instructions as to records specified in accordance with the operating instructions.

The information processing apparatus according to another embodiment of the present invention includes: an analysis unit configured to analyze record configuration of a print job, a dividing unit configured to divide the print job into records according to analysis results of the analysis unit, a management unit configured to associate and manage the print job and divided records, an operation control unit configured to instruct printing control operation as to the records managed by the management unit, an operation analysis unit configured to analyze instructions from the operation control unit, and a notifying unit configured to notify operating content obtained from the operation analysis unit to an image forming apparatus that performs print processing according to the print job.

Further features of the present invention will become apparent from the following description of exemplary embodiments (with reference to the attached drawings).

### BRIEF DESCRIPTION OF THE DRAWINGS

FIG. 1 is a diagram illustrating a configuration example of an overall POD system according to an embodiment of the present invention.

FIGS. 2A and 2B are diagrams illustrating an example of a workflow configuration using a job ticket.

FIG. 3 is a diagram illustrating an example of a job ticket configuration.

FIG. 4 is a diagram illustrating an example of a job ticket configuration.

FIG. 5 is a diagram illustrating an example of feature elements of the POD system according to an embodiment of the present invention.

FIG. 6 is a diagram illustrating a configuration example of a variable job generating application.

FIG. 7 is a diagram illustrating a configuration example of a job management application.

FIG. 8 is a diagram illustrating a function configuration example of a color MFP.

FIG. 9 is a diagram illustrating a function configuration example of an MFP control unit.

FIG. 10 is a diagram illustrating a data configuration of associated information of a job recorded in a job-record recording portion and a record.

FIG. 11 is a flowchart to describe processing operations according to the present embodiment.

FIG. 12 is a flowchart illustrating a record dividing processing with a PPML data configuration as a standard thereof.

FIGS. 13A and 13B are diagrams to describe the recording dividing processing shown in FIG. 12.

FIG. 14 is a flowchart illustrating record dividing processing with a reusable object configuration of a variable job (PPML) as a standard thereof.

FIG. 15 is a flowchart illustrating the executed job updating processing in FIG. 11.

FIG. 16 is a flowchart illustrating the data operating processing before RIP in FIG. 15.

FIG. 17 is a diagram to describe an example of a print job of variable printing according to the present embodiment.

FIG. 18 is a diagram to describe a dialog screen of a job management application.

FIG. 19 is a diagram illustrating an example in the case of performing a recording operation as to a print job (printing sequence change).

FIG. 20 is a diagram illustrating an example in the case of performing a recording operation as to a print job (hold).

FIG. 21 is a diagram illustrating an example in the case of performing a recording operation as to a print job (pause).

FIG. 22 is a diagram illustrating an example in the case of performing a recording operation as to a print job (printing sequence change).

FIG. 23 is a diagram illustrating a PPML data configuration of a print job.

FIG. 24 is a flowchart illustrating transfer origin record range determining processing.

FIG. 25 is a flowchart illustrating transfer destination record position determining processing.

FIG. 26 is a diagram illustrating another example in the case of performing a recording operation as to a print job (hold).

FIG. 27 is a diagram illustrating another configuration example of the POD system according to the present embodiment.

FIG. 28 is a diagram illustrating yet another configuration example of the POD system according to the present embodiment.

### DESCRIPTION OF THE EMBODIMENTS

Embodiments of the present invention will be described with reference to the appended diagrams. First, an image forming system which is applicable for the information processing apparatus relating to an embodiment of the present invention will be described.

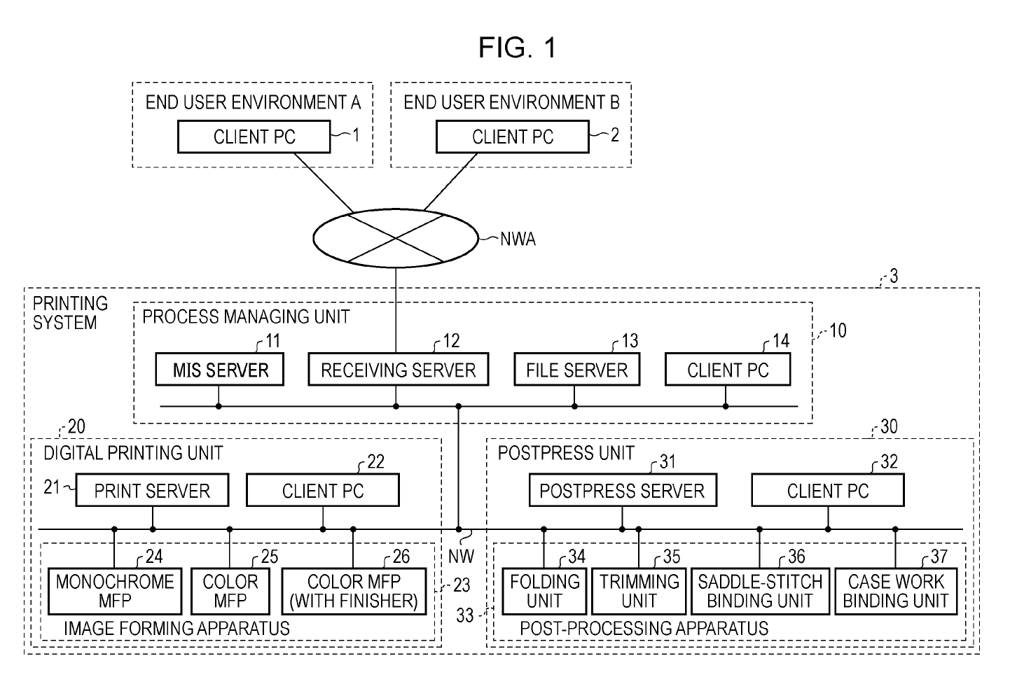

FIG. 1 is a block diagram illustrating an example of a basic configuration of an overall POD system (image forming system) according to an embodiment of the present invention. The POD system according to the present embodiment is made up of one or multiple end user environments and a printing system serving as a POD site environment. With the example shown in FIG. 1, a POD system is configured with a client PC (client computer) 1 of an end user environment A and a client PC 2 of an end user environment B and printing system 3 are connected via a network NWA such as the Internet.

The end user environment has an orderer (end user) which performs an order request for printing, whereby requests for print jobs or job status confirmation can be performed using each of the client PCs 1 and 2.

Also, the printing system (POD site environment) 3 has a process managing unit 10, digital printing unit 20, and postpress unit 30. The process managing unit 10, digital printing unit 20, and postpress unit 30 are connected so as to be communicable via the network NW within the printing system 3. Note that in the case that a function similar to the postpress unit 30 can be realized with the function or ability of a finishing device connected to the digital image forming apparatus such as a digital photocopies or digital multifunction device within the digital printing unit 20, the postpress unit 30 does not need to be provided.

The process managing unit 10 instructs work as to each process of the process managing unit 10, digital printing unit 20, and postpress unit 30, and manages the overall workflow of the present system configured with a computer or various types of devices. The process managing unit 10 performs receiving or storing of jobs from the above-described end user environment, builds work for each process as workflow, based on the job specifications, and efficiently schedules work for each device or each worker.

The process managing unit 10 has a MIS (Management Information System) server 11, receiving server 12, file server 13, and client PC 14. The MIS server 11, receiving server 12, file server 13, and client PC 14 are connected so as to be communicable via the network.

The MIS server 11 manages the workflow of the entire system from order receipt to delivery of the printed articles, and manages various management information and sales information across the board. The receiving server 12 uses the network NWA such as the Internet to receive a job from the end user environment. The job received from the receiving server 12 is managed with an ID number appended to the job. The receiving server 12 sends the ID number of the received job and information necessary for managing to the MIS server 11, and sends this along with other information such as image data according to the instructions of the MIS server 11 to a process downstream.

The file server 13 stores the job received from the end user environment in preparation of another order of the same document from the end user environment. The file server 13 generally stores image data and setting information of a job from a previous output (job ticket) together.

The client PC 14 has a job generating application installed therein, and outputs the job received from the end user environment in a format which can be processed with the printing system 3. For example, let us say that the client PC 14 receives a variable printing print job from the end user environment which is made up of basic content data and a variable printing instruction document of a data list. At this time, the client PC 14 converts the received variable printing print job into PPML (Personalized Print Markup Language) with the client PC 14, and outputs this to the digital printing unit 20.

The information handled with the MIS server 11, receiving server 12, file server 13, and client PC 14 in the process managing unit 10 is subjected to information exchange employing JDF (Job Definition Format) or the like. JDF is a job ticket with work instructions for the job. The process managing unit 10 performs job transfers or issues control commands with the information exchange employing JDF or the like, thereby providing a total automated workflow in cooperation with the digital printing unit 20, postpress unit 30 and so forth, centering around the process managing unit 10.

In accordance with print job work instructions received from the process managing unit 10, the digital printing unit 20 copies a document with a printing device such as a monochrome MFP (monochrome multifunction device) or color MFP (color multifunction device) or prints out a text or image file. For example, the digital printing unit 20 copies the document received from the end user environment according to work instructions of the print job. Also, a text or image file received from the end user environment, or an image file scanned with a scanning device, or a text or image file having editing these, is printed in accordance with work instructions of the print job via a printer driver or hot folder, for example.

The digital printing unit 20 has a print server 21, client PC 22, and image forming device group 23. The print server 21, client PC 22, and each image forming device in the image forming device group 23 are communicably connected via the network.

The print server 21 performs sending/receiving of information with the outside of the digital printing unit 20. The image information and setting information of the input print job is first input into the print server 21. Upon the job ending, the print server 21 notifies information such as status to the outside. Also, the print server 21 performs managing control of the inner portion of the digital print unit 20. The print server 21 manages a job generated in the digital printing unit 20 and an overall job input from the outside. Thus, an arrangement is made wherein the status of all of the devices and jobs in the digital printing unit 20 can be monitored, while controls can be performed such as job pausing, setting changes, printing restarting, or copying, transferring, or deleting or jobs.

The client PC 22 performs editing of an input application file, printing instructions, or input of a print-ready file. Also, the client PC 22 assists with monitoring or control of the devices and jobs managed in the printer server 21.

The image forming device group 23 has one or multiple image forming devices. In the example shown in Fig. 1, the image forming device group 23 has one monochrome MFP 24 and two color MFPs 25 and 26. The color MFPs 25 and 26 and the monochrome MFP 24 are image forming devices which have various functions such as scanning, printing, copying, and so forth, and since the functions and speed and cost differ by device, each is used according to the use thereof. Note that a finisher device is connected to the color MFP 26.

The postpress unit 30 controls post-processing devices in accordance with post-processing work instructions received from the process managing unit 10 or digital printing unit 20, and executes finishing processing as to the recording sheets output from the digital printing unit 20.

The postpress unit 30 has a postpress server 31, client PC 32, and post-processing device group 33. The postpress server 31, client PC 32, and each post-processing device in the post-processing device group 33 are communicably connected via the network.

The postpress server 31 is a computer which manages post-processing processes overall, and creates post-processing conditions which can be finished with the postpress unit 30, based on instructions for jobs received with the receiving server 12 or instructions for jobs output from the MIS server 11. The postpress server 31 performs instructions for post-processing process as requested from the end user environment as to the post-processing device group 33. Generally, the postpress server 31 uses an information exchange unit such as JDF with the outside of the postpress unit 30 to perform information exchange relating to internal commands or status of the postpress unit 30.

The client PC 32 assists with monitoring and control for devices and jobs managed with the postpress server 31. The post-processing device group 33 has one or multiple post-processing devices. The post-processing devices can be largely divided into three types. With the present embodiment, the following is defined.
(1) Inline finisher: a post-processing device wherein a sheet path is physically connected to the MFP, and operating instructions and status confirmation are also electrically connected with the MFP. Hereafter, in the case that a device is mentioned only as a finishing device, this refers to an inline finisher device.
(2) Nearline finisher: a post-processing device wherein a sheet path is not physically connected to the MFP, and a worker (operator) performs transport of output articles or settings for output articles, but operating instructions and status confirmation are electrically connected with the MFP via a communication arrangement such as a network.
(3) Offline finisher: a post-processing device wherein the MFP has no connection with a sheet path or communication arrangement for operating instructions or status confirmation, wherein a worker performs transport of output articles or settings for output articles, and wherein a worker manually inputs operations and the worker visually confirms the status reports generated by the devices.

Further, the post-processing device has a post-processing process to perform various types of sheet processing as to the output document which is subject to printing in the image forming device such as the MFP, and is controlled so as to process in binding form to provide to the end user. Post-processing processes include a trimming processing process, saddle-stitch binding processing process, case work binding processing process, folding processing process, hole-punching processing process, enclosure processing process, collating processing process, and so forth. With these various post-processing processes, sheet process processing of trimming, saddle-stitch binding, case work binding, folding, hole-punching, enclosing, collating and so forth as to the output document are realized.

A nearline finisher (may include an offline finisher) managed by the postpress server 31 includes a folding unit 34, trimming unit 35, saddle-stitch binding unit 36, case work binding unit 37, and so forth as exemplified in FIG. 1. Also, other than these, there are various devices such as a stapler, hole-punch, encloser, and collator and so forth. The postpress server 31 communicates with the post-processing device (nearline finisher) in the post-processing device group 33 using a protocol determined beforehand, grasps the state of the device or state of the job by performing sequential polling and so forth, thereby managing the executing status of the job.

Note that with the present embodiment, a configuration to enable executing of the above-described multiple sheet process processing each with separate post-processing devices may be used, or a configuration to enable executing of the multiple types of sheet process processing with one post-processing device may be used. Also, all of the post-processing devices do not need to be provided, and an arrangement may be made wherein, of multiple post-processing devices, one of the post-processing devices is provided in the present system. Also, with the POD system according to the present embodiment, all of the printing jobs do not need to be processed with the postpress unit 30, and an arrangement may be made wherein the post-processing processes may be performed with the color MFP 26 which has a finisher device.

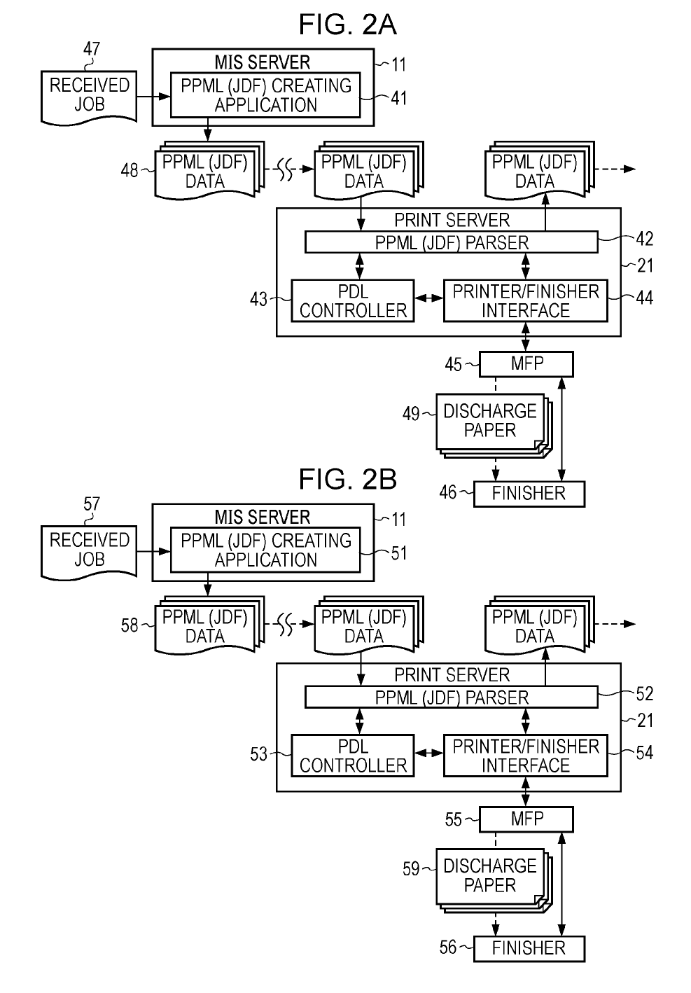

Next, a commercial printing workflow using a job ticket with the POD system in the commercial printing field will be described with reference to FIGS. 2A through 4. FIGS. 2A and 2B are diagrams illustrating an example of workf low configuration. FIG. 2A shows a workf low configuration example realized with a job ticket, and Fig. 2B shows a workflow configuration example realized with a variable printing print job (variable job). In the example shown in FIGS. 2A and 2B, JDF is employed as the job tickets, and PPML is employed as the variable job.

In FIG. 2A, the MIS server 11 has a JDF creation application 41. The JDF creation application 41 creates JDF data 48 similar to the job ticket described in the work instructions in the workflow, based on the received job 47.

Also, the print server 21 has a JDF parser 42, PDL control 43, and printer/finisher interface 44. The JDF parser 42 interprets the JDF data 48. The PDL controller 43 processes various types of PDL (Page Description Language) data such as PDF (Portable Document Format)/PS (PostScript) and so forth. The printer/finisher interface 44 is an interface to connect with the printer engine of the MFP 45 or the like, or the finisher device 46.

A workflow with a job ticket is realized as below. Upon the received job 47 being input in the MIS server 11, the MIS server 11 creates JDF data 48 based on the received job 47 with the installed JDF creation application 41.

Upon the created JDF data 48 being sent to the print server 21, the print server 21 interprets the JDF data 48 with the JDF parser 42, and executes the job as to the digital printing unit. For example the JDF data 48 is specified with attributes such as output sheet size and duplex/simplex printing and N-up. The print server 21 processes the PDL data referenced with the JDF data 48 with the PDL controller 43, according to the content in the JDF data 48, and instructs the MFP 45 to execute printing via the printer/finisher interface 44.

An output document 49 (59 in FIG. 2B) output by the printing executing by the MFP 45 is conveyed to the finisher 46. If the attributes such as case work binding or saddle-stitch binding or trimming are specified in the JDF data 48, the print server 21 instructs the finisher 46 via the printer/finisher interface 55 to execute post-processing in accordance with the content in the JDF data 48.

Next, a variable job workflow will be described. In FIG. 2B, the MIS server 11 has a PPML creation application 51 to create PPML data 58 which is a variable job based on the received job 57. The JDF data which is similar to the job ticket wherein work instructions for the workflow are described is recorded in the PPML data 58. Also, the print server 21 has a PPML parser 52 to interpret the PPML data 58, a PDL controller 53 to process various types of PDL data, and a printer/finisher interface 54 to connect with the MFP 55 and finisher device 56.

Upon the received job 57 input in the MIS server 11, the MIS server 11 creates PPML data 58 based on the received job 57 with the installed PPML creation application. Upon the created PPML data 58 being sent to the print server 21, the print server 21 interprets the PPML data 58 with the PPML parser 52, and executes the job as to the digital printing unit. For example, an object which is drawn, shared in the background across all pages, and an object which changes for each page, are specified in the PPML data 58. Also, the JDF data 48 recorded in the PPML data 58 is specified with attributes such as output sheet size and duplex/simplex printing and N-up.

The print server 21 processes the PDL data referenced with the PPML data 58 with the PDL controller 53, according to the JDF content, and instructs the MFP 55 to execute printing via the printer/finisher interface 54. The processing at and after the printing execution with the MFP 55 is the same as the case of a workflow with a job ticket as described above, so the description thereof will be omitted.

Note that with the example shown in FIG. 2, the JDF creation application 41 and PPML creation application 51 are within the MIS server 11 but these may be arranged within the client PC 14.

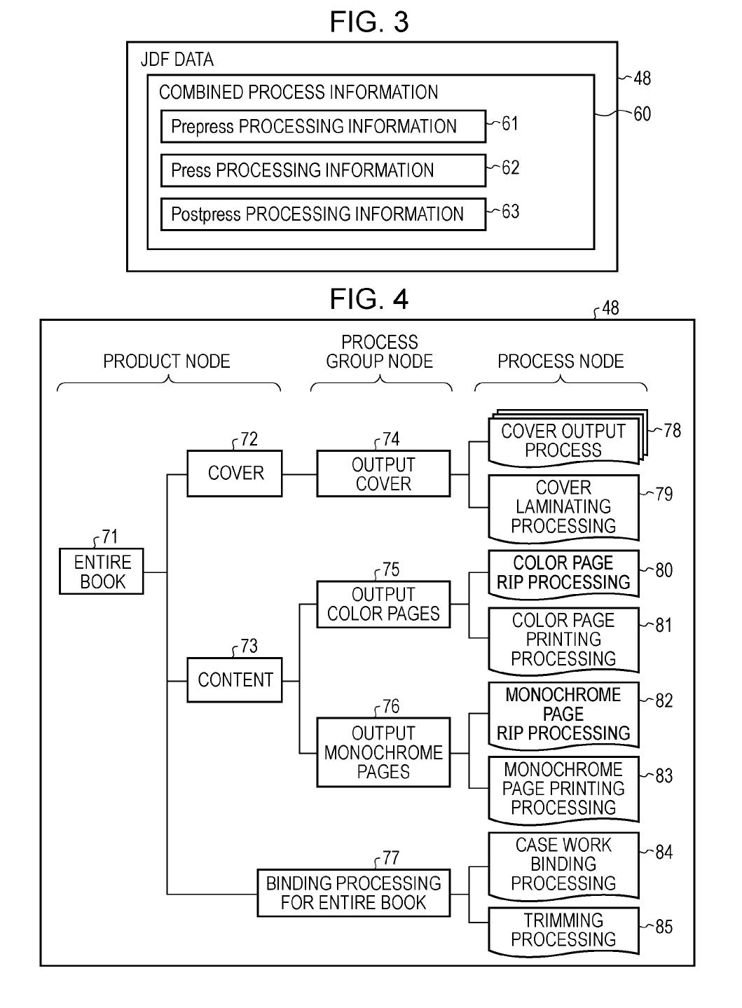

FIG. 3 is a diagram illustrating an example of a job ticket configuration with the POD system of the present embodiment. In FIG. 3, reference numeral 48 denotes the entire JDF data as the job ticket.

Reference numeral 61 denotes Prepress processing information, wherein is described an instruction group for multiple Prepress processing showing how to subject the content data such as PDF to image processing, and how to arrange the data. Reference numeral 62 denotes Press processing information, wherein is described an instruction group for multiple Press processing showing how to output the image data created with the Prepress processing into a document. Reference numeral 63 denotes Postpress processing information, wherein is described an instruction group for multiple Postpress processing showing how to subject the document output according to the instructions of the Press processing to post-processing (e.g. case work binding).

Reference numeral 60 denotes Combined Process information which is a collective of the Prepress processing information 61, Press processing information 62, and Postpress processing information 63 into one processing. Normally, with the color MFP 26 and so forth which handles the digital printing, the results after ending executing all of the processing of the Prepress processing, Press processing, and Postprocess processing as to one input of a print job becomes one single output. Thus, Prepress processing, Press processing, and Postprocess processing is performed sequentially, and in the case of performing instructions to output a single output, the Combined Process is used. For instructions as to a digital image forming apparatus such as an MFP which can execute at least two of the processing of Prepress processing, Press processing, and Postprocess, the Combined Process is always used.

FIG. 4 is a diagram showing an example of a job ticket configuration according to the POD system of the present embodiment. With FIG. 3, the configuration of the job ticket is shown as a type of executing processing, but the JDF which expresses a job ticket is written with an XML (Extensible Markup Language) format, and can be expressed with a node hierarchical configuration. FIG. 4 shows a hierarchical diagram relating to binding processing with JDF, as an example thereof.

In order to create a “book” 71, a cover 72 is created, the content 73 is created, and various processes are used such as binding, whereby a “book” is completed which can be delivered to the end user. In the event of configuring an output article with the JDF, the process to form the physical output article is called a product node, the processing process to form the product node is called a process node, and a collective of process nodes with intermediate-stage elements which create the product node is called a process group node.

The example shown in FIG. 4 includes cover output 74 in the process group node under the layer for cover 72 in the product node, and in the subsequent layer is a cover output process 78 and cover laminating process 79 in the process node. Also, a color page output 75 is in the process group node under the layer for content 73 in the product node, and in the subsequent layer is color page RIP (Raster Image Processor) processing 80 and color page printing processing 81 in the process node. Also, a monochrome page output 76 is in the process group node under the layer for content 73 in the product node, and in the subsequent layer is monochrome page RIP processing 82 and monochrome page printing processing 83. A binding processing 77 for the entire book in the process group node is under the layer for a book 71 in the product node, and in the subsequent layer is case work binding processing 84 and trimming processing 85.

Also, the Prepress processing which has an instruction group described in the Prepress processing information 61 shown in FIG. 3 corresponds to the color page RIP processing 80 and monochrome page RIP processing 82. The Press processing which has an instruction group described in the Press processing information 62 corresponds to the cover output process 78, cover laminating process 79, color page printing processing 81, and monochrome page printing processing 83. The Postpress processing which has an instruction group described in the Postpress processing information 63 corresponds to the case work binding processing 84 and trimming processing 85.

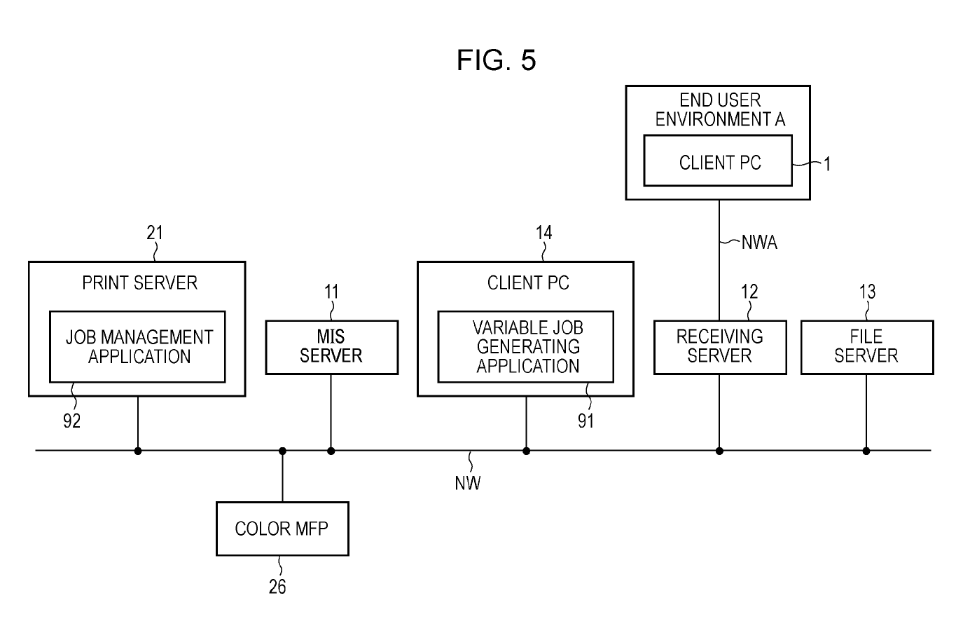

The POD system according to the present embodiment will be described in detail. Note that hereafter, for ease of description, a minimal configuration POD system as shown in FIG. 5 will described as an example. FIG. 5 is a configuration diagram showing an example of feature elements of the POD system according to the present embodiment. That is to say, the configuration shown in FIG. 5 has only the configuration necessary for describing the present embodiment in the POD system configuration shown in FIG. 1, hereafter the configuration shown in FIG. 5 will be described. Note that with FIG. 5, components which have the same function as the components shown in FIG. 1 have the same reference numerals.

As shown in FIG. 5, the process management unit in the printing system is made up a receiving server 12, MIS server 11, client PC 14, and file server 13, connected to a client PC 1 of the end user environment A via the network NWA. Also, the digital printing unit is made up of a print server 21 and color MFP 26. The internal configuration of the color MFP 26 is made up of a color MFP main unit to process from receipt of the print job to the output of the printed document according to information recorded in the job, and an inline finisher connected as a conveying path of the printing document from the color MFP main unit.

A MIS server 11, receiving server 12, file server 13, client PC 14, print server 21, and color MFP 26 are communicably connected via a network NW such as a LAN. The MIS server 11 manages the workflow of the entire system from receipt until delivery of the printed article. Specific processing content is that the job received with the receiving server 12 is converted to PPML data which is a variable printing print job with the client PC 14, and the print job is further sent from the client PC 14 to the MIS server 11 and recorded.

The MIS server 11 has a function to manage the processing schedule of the print jobs for the entire printing system, and manages the variable printing print jobs as print jobs to be processed within the printing system along with the processing schedule information. The digital printing unit (print server 21 in the example in FIG. 5) is instructed with the start of the print job, and receives status information indicating the current processing state from the digital printing unit. Also, the MIS server 11 receives a print job ending notification from the digital printing unit. Such various received information is communicated to an operator via the MIS server or a display apparatus such as a CRT connected to the client PC 14.

As shown in FIG. 5, the client PC 14 has a variable job generating application 91 which includes a program for generating a variable printing print job. Also, the print server 21 has a job management application 92 which manages print jobs relating to variable printing or other printing.

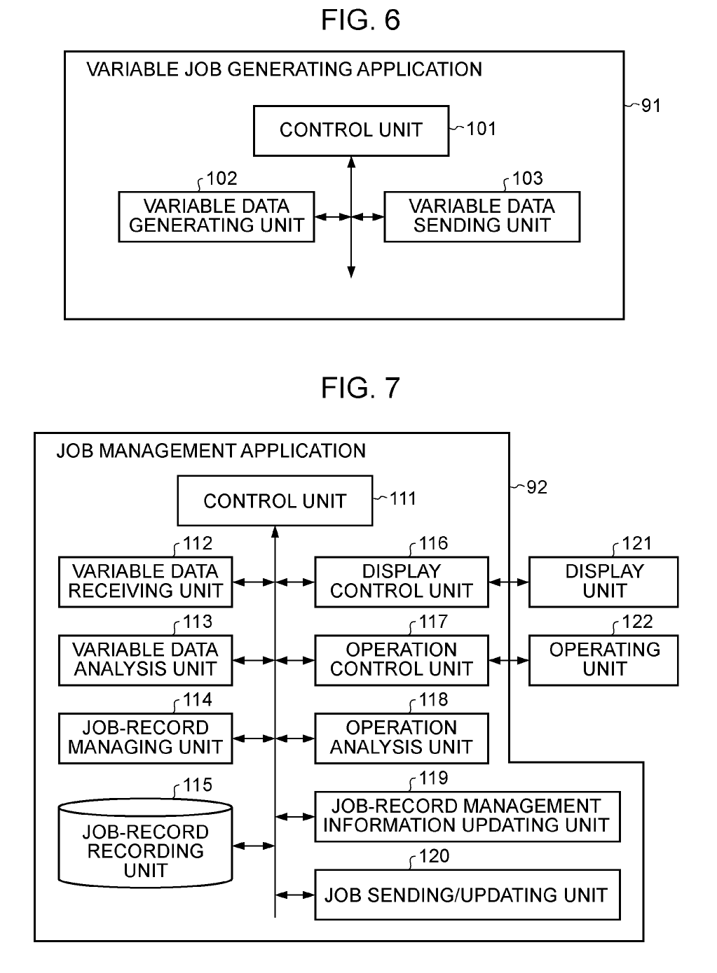

FIG. 6 is a block diagram showing a configuration example of the variable job generating application 91. With the present embodiment, the variable job generating application 91 is installed in a storage device such as the hard disk of the client PC 14, and operates on the client PC 14.

The control unit 101 controls the operations of the entire variable job generating application 91. A variable data generating unit 102 generates variable data according to instructions input by the operator or the like. A variable data sending unit 103 transfers the variable data generated with the variable data generating unit 102 to the job management application 92 or another module (MIS server 11 or the like) which can process the variable printing print job. With the present embodiment, the variable printing print job is sent from the variable job generating application 91 to the job management application 92, but an arrangement may be made to directly send the variable printing print job to the color MFP 26.

FIG. 7 is a block diagram showing a configuration example of the job management application 92. With the present embodiment, the job management application 92 is installed in a storage device such as the hard disk of the print server 21, and is operated on the print server 21.

A control 111 controls the processing of the entire job management application. A variable data receiving unit 112 receives a variable printing print job from the client PC 14 or MIS server 11.

A variable data analysis unit 113 analyzes the variable printing print job (record configuration of print job) received from the variable data receiving unit 112, and divides this in increments of records. Specifically, the variable data analysis unit 113 detects boundaries (breaks, segments) of the records in the print job made up of the received multiple records, and correlates each record with the printing page corresponding to each record, based on the detection results thereof. The variable data analysis unit 113 makes up the analysis unit, processing unit, and dividing unit of the present invention.

A job-record management unit 114 associates and manages the record information divided in the variable data analysis unit 113 and the job information. The record information includes information correlating each record relating to the variable printing print job and the printing pages. The record information which the job-record management unit 114 manages is recorded in a job-record recording unit 115 made up of a recording apparatus such as a hard disk. That is to say, the job-record storage unit 115 records the analysis results of the print job from the variable data analysis unit 113 as job-record management information along with the print job.

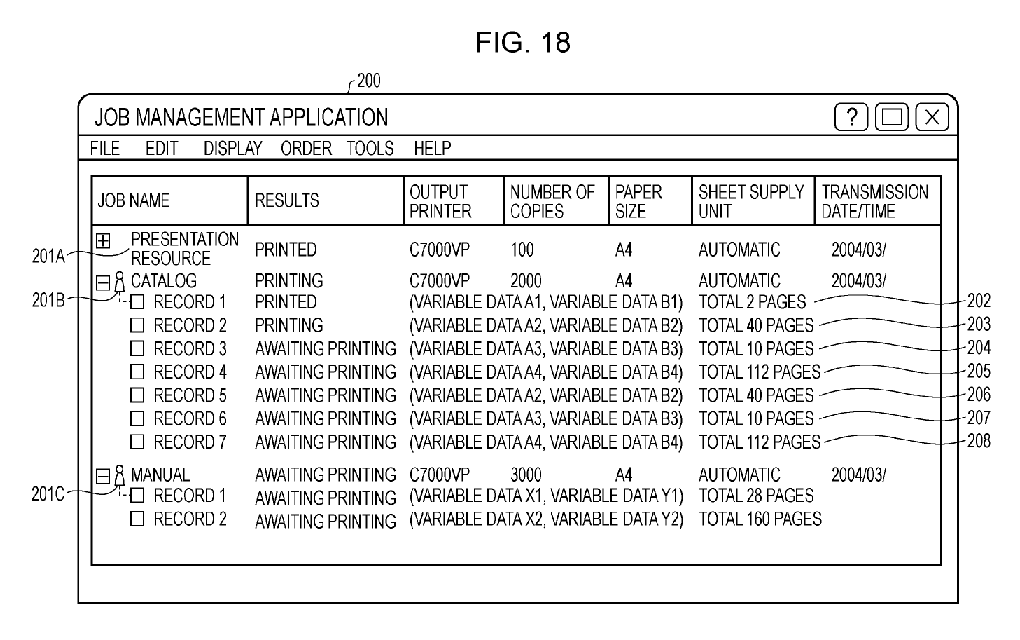

A display control unit 116 performs display control to display the information managed with the job-record management unit 114 on a display unit 121 such as a display or the like. The display control unit 116 displays a list of records making up the print job as shown in the later-described FIG. 18 on the display unit 121, based on the processing results with the variable data analysis unit 113, for example.

An operation control unit 117 controls processing whereby an operator performs operations for records using the operating unit 122 such as a keyboard or mouse (printing control operations), as to the records in the list displayed on the display unit 121. For example, the operation control unit 117 receives operating instructions for records whereby an operator has used the operating unit 122 as to the records in the displayed list (operation instructions for printing control). Operation instructions for the records (operation instructions for printing control) include printing sequence changing, deleting (hold), and pausing.

An operation analysis unit 118 analyzes input information controlled with the operation control unit 117 (information of record operation instructions). The operation analysis unit 118 determines whether or not a drag-and-drop operation of the selected record by a mouse serves as a record moving instruction, for example.

A job-record management information updating unit 119 updates information recorded in the job-record recording unit 115, i.e. managed with the job-record management unit 114, based on the analysis results from the operation analysis unit 118. A job sending/updating unit 120 sends the information such as the print job to the image forming apparatus such as the color MFP 26 (information according to operation content in the case of an update), and updates the information recorded in the job-record recording unit 115. Thus, the function as an operating unit is realized with the operation control unit 117, operation analysis unit 118, job-record management information updating unit 119, and job sending/updating unit 120.

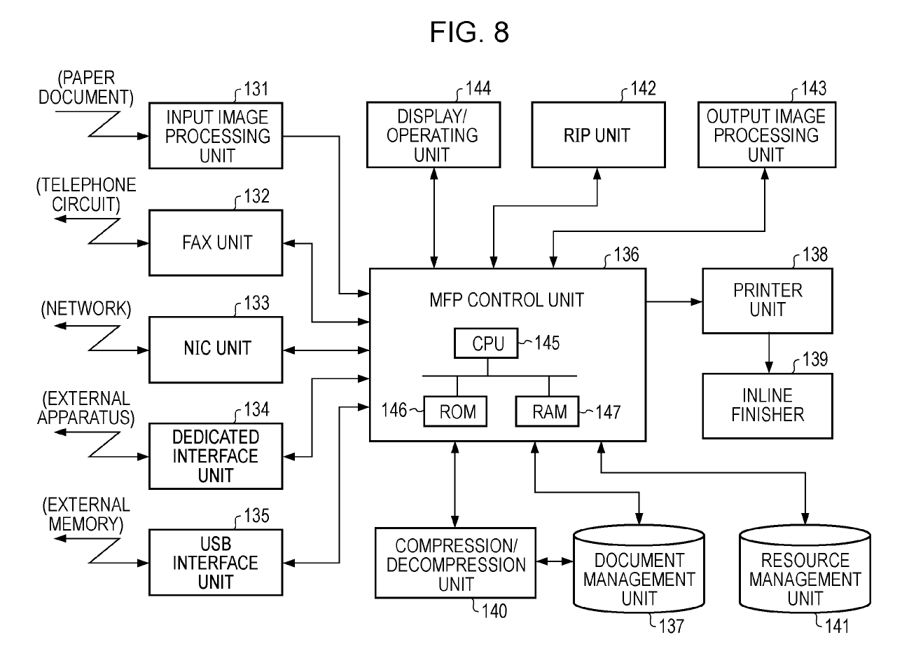

FIG. 8 is a block diagram illustrating a function configuration example of the color MFP 26. The MFP has memory such as a hard disk which can store data for multiple jobs within the apparatus itself, and is an image forming apparatus having multiple functions. The functions of an MFP are a copy function which enables printing with a printer via memory as to job data output from a scanner, a printing function which enables printing with a printer unit via memory as to job data output from an external device such as a computer.

Also, the configuration of the printing system according to the present embodiment has a MFP with multiple functions as described above, but a configuration may be used wherein an image forming apparatus having only a printing function and finishing function may be used. Also, a configuration may be used wherein only one or the other type of image forming apparatus is provided, or a configuration may be used wherein whichever type of image forming apparatus is used, multiple apparatuses are provided. Any configuration may be used if controls for the present embodiment can be realized.

As shown in FIG. 8, the color MFP 26 has an input image processing unit 131, FAX unit 132, NIC unit 133, dedicated interface unit 134, and USB interface unit 135. The input image processing unit 131 reads images such as from a paper document, and subjects the read image data to image processing. The FAX unit 132 performs sending/receiving of the image using a telephone circuit, of which a facsimile or the like is representative. The NIC (Network Interface Card) unit 133 uses a network to handle the image data and device information. The dedicated interface unit 134 performs information exchange of image data and so forth with an external device. The USB (Universal Serial Bus) interface 135 sends/receives the image data with a USB device represented by a USB memory (a type of removable media).

A MFP control unit 136 controls the operations of the color MFP 26. For example, the MFP control unit 136 temporarily stores image data according to the use of the MFP, or determines the sending/reception path of the data. With the present embodiment, let us say that the color MFP 26 can process PPML data which is a representative format of a variable printing print job. That is to say, the MFP control unit 136 controls printing jobs in the color MFP 26 of all printing jobs which include variable printing print jobs.

The MFP control unit 136 has a CPU 145, ROM 146, and RAM 147, and controls operations for the entire MFP according to a program stored in the storage device such as the ROM 146 or an unshown hard disk. The ROM 146 stores a control program and so forth of the CPU 145. The RAM 147 is memory for temporarily saving a program or image data.

A document management unit 137 is configured with memory such as a hard disk which can store multiple image data. For example, with a control unit provided on the image forming apparatus (e.g. CPU 145 of the MFP control unit 136) becomes the primary unit and controls multiple types of image data such as various image data input externally so as to be storable in the document management unit 137. The image data input externally includes image data from the input image processing unit 131, image data of a facsimile job input via the FAX unit 132, and image data from an external device such as a computer which is input via the NIC unit 133. Also, there is image data input via the dedicated interface unit 134 or USB interface unit 135.

The image data stored in the document management unit 137 is then read out as appropriate, transferred to the output unit of a printer unit 138 or the like, and controls to enable output processing such as printing processing by the printer unit 138. Also, with the instructions from the operator or the like, the image data read from the document management unit 137 is controlled to enable transfer to an external device such as a computer or other image forming apparatus.

A compression/decompression unit 140 performs compression/decompression of image data. The compression/decompression unit 140 compresses and stores image data as needed in the event of storing image data in the document management unit 137, or conversely, decompresses and outputs to the original image data in the event of reading the image data compressed and stored from the document management unit 137. Also, upon compressed data such as JPEG, JBIG, ZIP and so forth being input in the MFP via the network, the compression/decompression unit 140 unpacks (decompresses) the compressed data thereof.

A resource management unit 141 has various types of parameter tables and so forth stored within which are commonly handled such as fonts, color profile, gamma table, and so forth. The resource management unit 141 can call out the various types of parameter tables stored therein as needed, and can store new parameter tables or correct and update parameter tables.

A RIP unit 142 performs RIP processing as to the input PDL data. An output image processing unit 143 performs image processing for printing as needed as to the image to be printed. Intermediate data for image data created in the event of RIP processing with the RIP unit 142 or image processing with the output image processing unit 143 and print-ready data (bitmap data for printing or compressed data thereof) can also be stored in the document management unit 137 as needed.

The data obtained from the RIP processing with the RIP unit 142 or the image processing with the output image processing unit 143 is sent to the printer unit 138 to perform image forming, and is printed out with the printer unit 138. The printed-out printing document sheet is conveyed to an inline finisher 139 which is a post-processing unit, and dividing processing of the sheets and finishing processing of the sheets are performed.

A display/operation unit 144 is for selecting the above-described various flows and functions and instructing operations. The display/operation unit 144 is configured so as to display a preview of the image data stored in the document management unit 137, and enable operations such as printing in the case that confirmation indicates OK.

The MFP control unit 136 has the role of smoothly flowing the jobs, and depending on the usage of the MFP, path (data path) switching is performed as exemplified below. The description below omits the processing of the compression/decompression unit and post-processing units which are used as needed or the MFP control unit serving as the core of the entire system, and description is given so the overall flow can be understood.
(A) FAX receiving function: FAX unit→output image processing unit→printer unit
(B) network printing: NIC unit→RIP unit→output image processing unit→printer unit
(C) printing from external device: dedicated interface unit→output image processing unit→printer unit
(D) printing from external memory: USB interface unit→RIP unit→output image processing unit→printer unit
(E) box printing function: document management unit→printer unit

Box printing is a function which divides the memory in the document management unit 137 by job or by user to temporarily save the data, and performs data input/output according to identification information (user ID, password, and so forth).

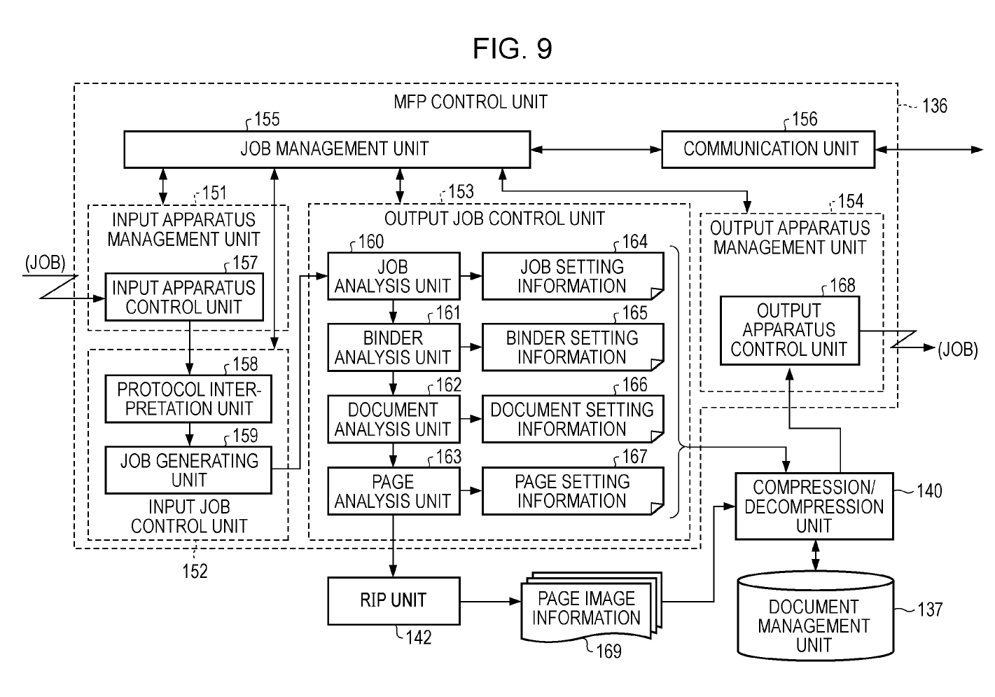

FIG. 9 is a block diagram showing a function configuration example of the MFP control unit 136. The MFP control unit 136 is largely made up of five portions (input device management unit 151, input job control unit 152, output job control unit 153, output device management 154, and job management unit 155).

The input device management unit 151 manages the input devices, and has an input device control unit 157. Input signals to the input device management unit 151 may include PDL data and image data from the file server 13 and JDF and PPML or the like from the job management application 92 and job management unit 155. The input device control unit 157 generates and sends a command for the operation request based on these input signals.

The input job control unit 152 interprets the input job and generates an internal job. The input job control unit 152 has a protocol interpreting unit 158 and job generating unit 159. The protocol interpreting unit 158 receives a command signal called a command (protocol) which indicates a series of operation requests sent from the input device control unit 157, interprets the overall operation requests based on the received command, and converts this into operation sequences which can be understood within the MFP. The job generating unit 159 generates an internal job describing how to process the processing for the input job with the MFP, based on the processing results from the protocol interpreting unit 158. The generated job defines each scenario such as what sort of processing is the generated job subjected to in the MFP and wherein the job will be sent, and flows within the MFP according to such scenario.

The output job control unit 153 arranges the job setting information. The output job control unit 153 has a job analysis unit 160, binder analysis unit 161, document analysis unit 162, and page analysis unit 163, whereby job setting information and image information is created with these analysis units 160 through 163.

The job analysis unit 160 analyzes details of the job setting information 164 relating to the entire job such as the document name or number of copies for printing, specifying the sheet output tray for the output destination, the binder sequence for a job made up of multiple binders, and so forth. The binder analysis unit 161 analyzes details of the binder setting information 165 relating to the entire binder such as setting for the binding method, position of staples, and document sequence for a binder made up with multiple documents. The document analysis unit 162 analyzes details of the document setting information 166 relating to the entire document such as specifying duplex printing, adding a cover sheet or inserted sheet, and page sequence for a document made up with multiple pages.

The page analysis unit 163 analyzes details of the page setting information 167 relating to the entire page for various types of settings such as image resolution, image orientation (landscape/portrait) and so forth, and in the case that PDL data is input, calls the RIP unit 142 and performs rasterizing processing. Note that when generating image information, the RIP unit 142 is called, and page image information 169 is generated with the rasterizing processing. The page image information 169 is compressed with the compression/decompression unit 140, following which is associated with the setting information and stored in the document management unit 137.

The output device management unit 154 is for assigning an output device, and has an output device control unit 168. The page image information saved in the document management unit 137 is read out together with the associated setting information, and after decompression with the compression/decompression unit 140, the setting information and decompressed image information are sent as a pair to the output device management unit 154. The output device control unit 168 schedules the processing in the MFP as to which device will be used such as the printer unit or inline finisher.

The job management unit 155 transmits instructions from the job management application 92 to the MFP control unit 136 and performs control of the print job. Also, the communication unit 156 sends/receives printing status between the job management application 92 and receives print job processing instructions. The job management unit 155 receives PPML or JDF which is a print job from the print job management application 92 via the communication unit 156, and receives instructions such as the print job starting, interrupting, stopping, and changing processing content and so forth. The job management unit 155 sends the instructions to change the print job processing according to the instruction content thereof to each function portion in the MFP, and sends the status information relating to the print job being executed in the MFP to the MIS.

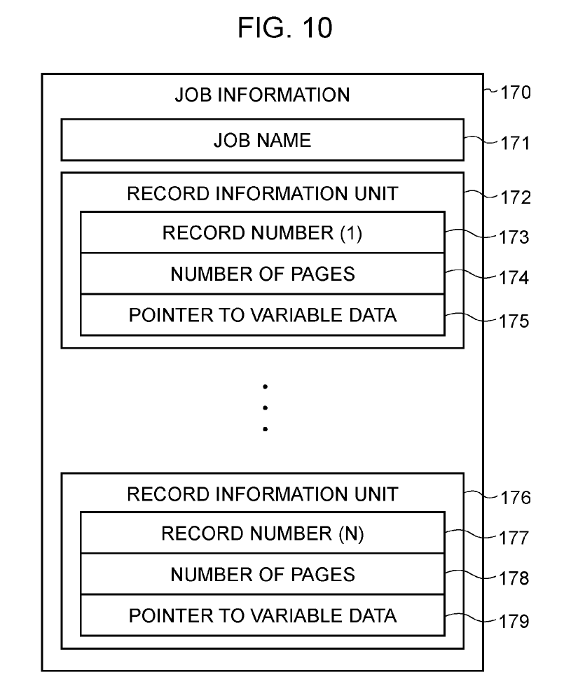

FIG. 10 is a diagram showing data configuration of associated information of jobs and records recorded in the job-record recording unit 115 with the job-record management unit 114. Reference numeral 170 denotes a job information portion showing one entire job, and reference numeral 171 denotes a job name portion to record the job name of each job. Reference numerals 172 and 176 denote record information portions to record information of each record making up the job. With the example shown in FIG. 10, the record information portion for the records recorded between a record information portion 172 for the first record and a record information portion 176 for the last record is omitted from the diagram.

With each record information unit 172 and 176, the reference numerals 173 and 177 denote the number of each record. Reference numerals 174 and 178 denote the number of pages recorded as to how many pages each record is made up from. Reference numerals 175 and 179 denote pointers to the variable data to indicate the lead address of the data making up each record in the PPML.

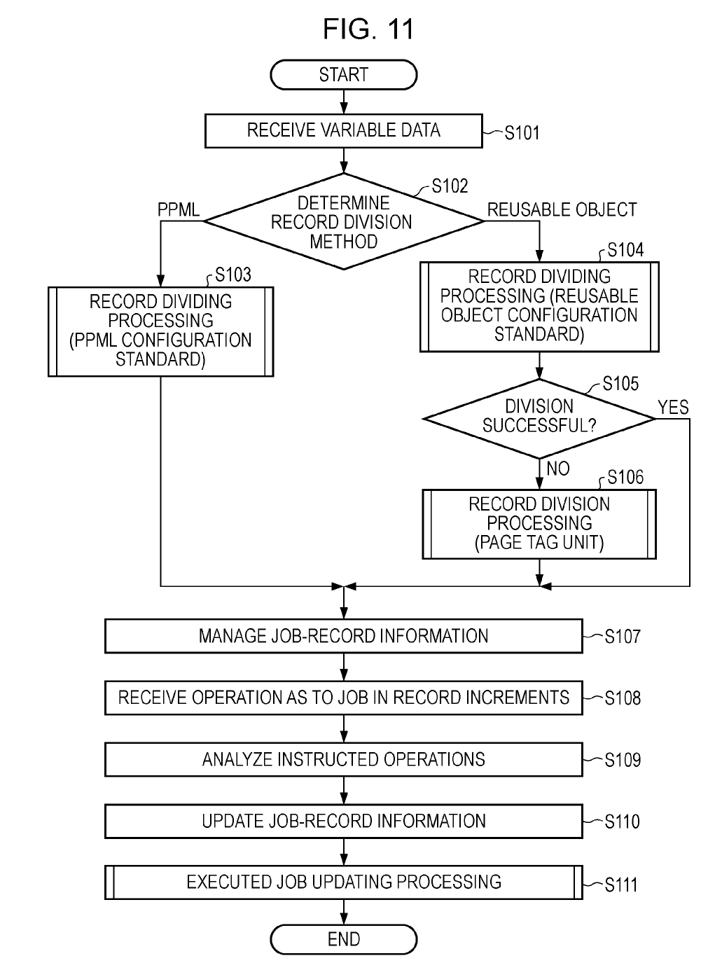

FIG. 11 is a flowchart to describe the processing operations according to the present embodiment. FIG. 11 shows processing from the time that the job management application 92 receives a variable printing print job from the variable job generating application 91, until instructions are given to the color MFP 26 for record operations (operations for printing control as to the records).

In step S101, the job management application 92 receives a variable printing print job from the variable job generating application 91 via the variable data receiving unit 112.

In step S102, the variable data analysis unit 113 of the job management application 92 determines a method to divide the variable jobs into record increments. As a result of the determination, in the case of dividing the records according to the PPML data configuration, the flow is advanced to step S103, and in the case of dividing the records according to the variable job (PPML) reusable object configuration, the flow is advanced to step S104. With the present embodiment, in the case that the variable job generating application 91 is a product of the same company (manufacturer) as the job management application, there may be certain rules in the PPML data configuration. Therefore, in the case that the manufacturing source is the same for both applications, record division needs to be performed in accordance with the rules of the PPML data configuration, to the flow is advanced to step S103. In other cases, the flow is advanced to step S104.

In step S103, the variable data analysis unit 113 performs division in increments of records based on the PPML data configuration. The details of record division processing with step S103 will be described later. Upon ending the record division processing in step S103, the flow is advance to step S107.

Also, in step S104, the variable data analysis unit 113 performs division in increments of records based on the reusable object configuration. The details of the record division processing in step S104 will be described later.

Upon the record division processing in step S104 ending, in step S105 the variable data analysis unit 113 determines whether or not the record division has succeed, and in the case of success the flow is advanced to step S107, and in the case of failure the flow is advanced to step S106. In step S106, the variable data analysis unit 113 performs division in increments of PPML “PAGE” tags, and when this is ended, the flow is advanced to step S107.

In step S107, in the job management application 92, the job-record management unit 114 performs job-record information recording as to the job-record recording unit 115.

With the above processing, a list of records for a print job such as shown in the later-described FIG. 18 can be displayed based on job-record information recorded in the job-record recording unit 115. Operational instructions can be input by an operator or the like operating an operating unit 122 (e.g. keyboard or mouse) as to the records in the displayed list.

In step S108, the operation control unit 117 receives an operation for printing control as to a print job in increments of records. In step S109, the operation analysis unit 118 analyzes operations as to records specified in step S108.

In step S110, the job-record management information updating unit 120 updates the information recorded in the job-record recording unit 115, based on the analysis results in step S109. In step S111, the job sending/updating unit 120 sends the updated information in the job-record recording unit 115 to the color MFP 26 which is an output device, and reflects the results thereof to the variable job (print job) during executing of such job with a device.

An overview of a processing method with the color MFP 26 will be described. With the color MFP 26, instructions from the job management application 92 are reflected in the variable job.

With a first method, processing is performed such as changing sequence or deleting records by operating the data already subjected to RIP processing with the color MFP, based on the received data. In the case that RIP processing is ended for the page data making up all of the record data with the variable job in the color MFP 26, the first method is executed.

With a second method, the updated PPML data is received, the PPML data thereof is sent to the color MFP 26, and the change content is determined in the color MFP 26 and editing is executed in increments of records. In the case that RIP processing is not ended for the variable job to be subject to operation with the color MFP 26, the second method is executed.

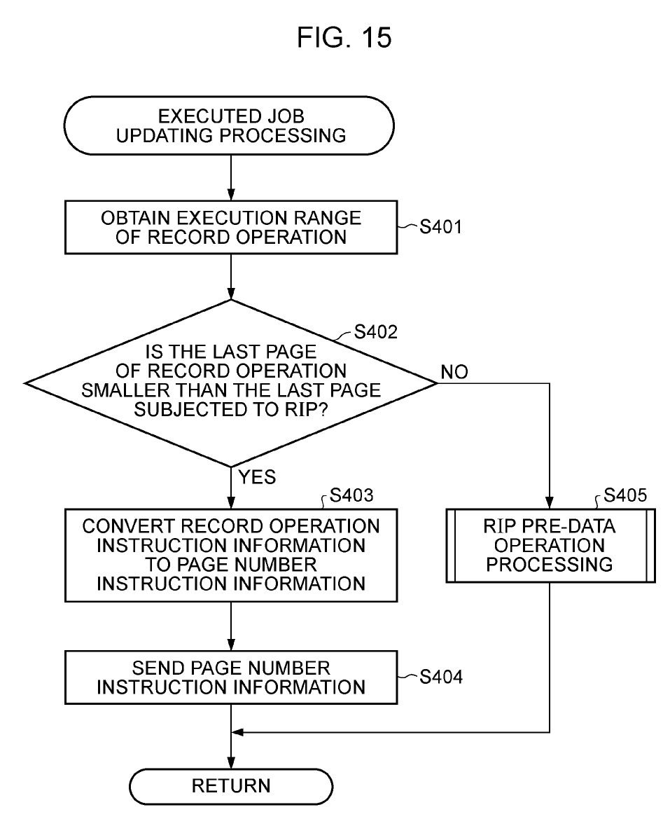

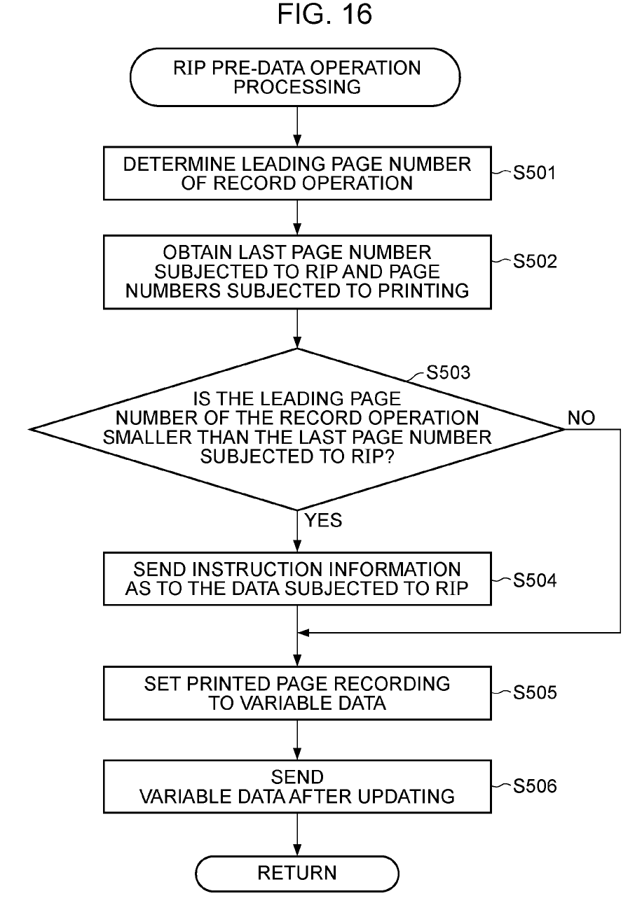

The usage methods of the above-described first method and second method will be described later with reference to FIGS. 15 and 16.

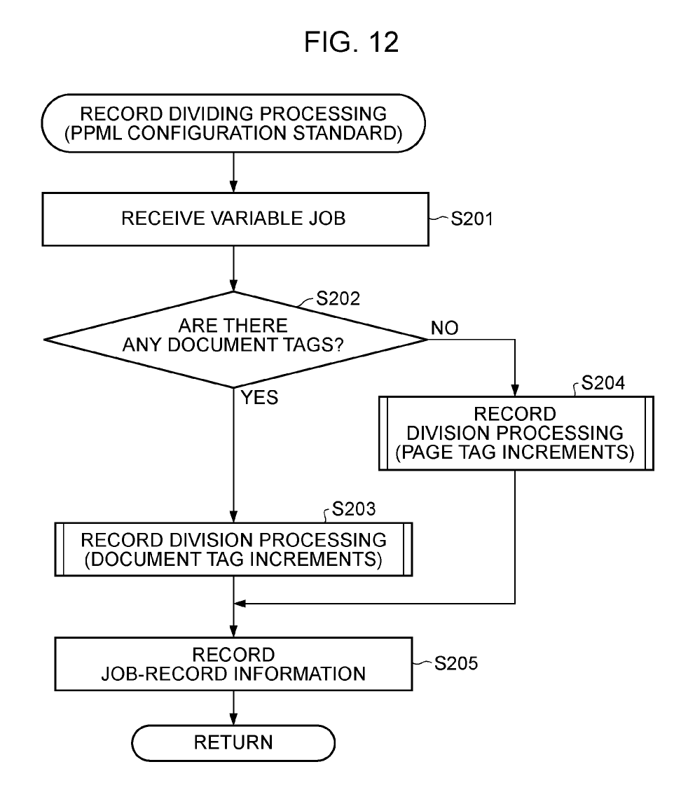

FIG. 12 is a flowchart showing the record division processing in step S103 as shown in FIG. 11, i.e. processing to divide records of the variable job based on the PPML data configuration.

First, in step S201, a variable job is received from the variable job generating application 91, similar to step s101.

In step S202, the variable data analysis unit 113 determines whether or not there is a “DOCUMENT” tag in the PPML data, and if there is, the flow is advanced to step S203, and if not, the flow is advanced to step S204.

In step S203, the variable data analysis unit 113 executes record dividing processing as to the variable job in increments of “DOCUMENT” tags. On the other hand, in step S204, the variable data analysis unit 113 executes record dividing processing as to the variable job based on “PAGE” tags.

In step S205, the variable data analysis unit 113 records job-record management information which is the processing results in the job-record recording unit 115.

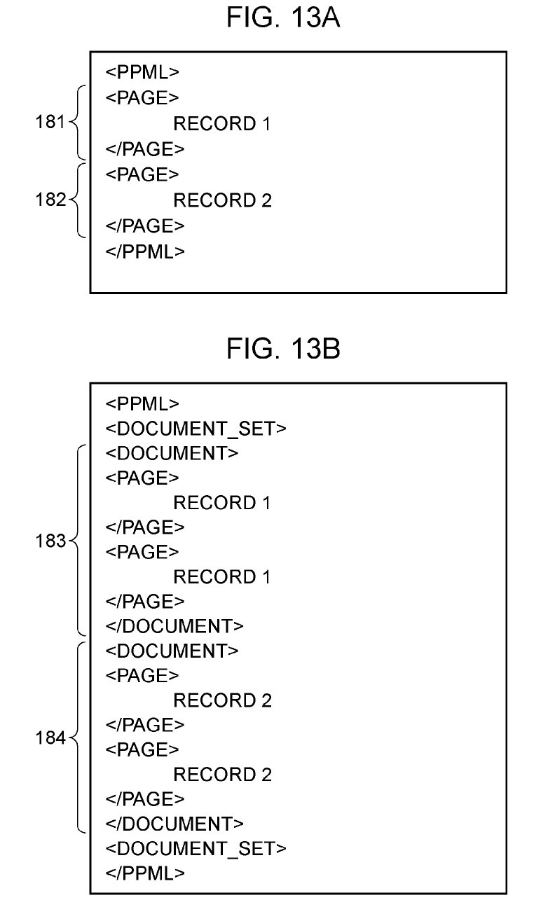

FIGS. 13A and 13B are diagrams for describing the record dividing processing shown in FIG. 12. FIG. 13A shows a configuration example of PPML data subjected to record division based on “PAGE” tags, and FIG. 13B shows a configuration example of PPML data subjected to record division based on “DOCUMENT” tags.

As shown in FIG. 13A, in the case there is no “DOCUMENT” tag in the PPML data, the variable data analysis unit 113 segments as “PAGE” tag units 181 and 182 in the PPML. Also, as shown in FIG. 13B, in the case there is a “DOCUMENT” tag in the PPML data, the variable data analysis unit 113 segments as “DOCUMENT” tag units 183 and 184 in the PPML.

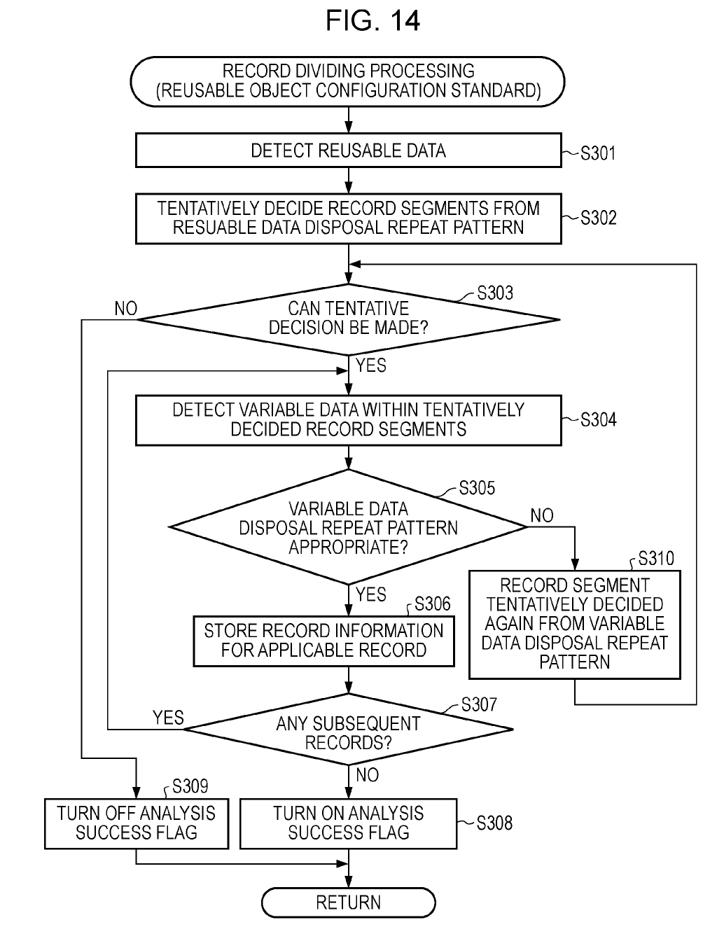

FIG. 14 is a flowchart showing the record dividing processing in step S104 as shown in FIG. 11, i.e. processing to divide records based on the reusable object configuration of the variable job (PPML).

In step S301, the variable data analysis unit 113 analyzes the PPML data and detects reference instructions for the reusable data (reusable object). The reusable data (reusable object) is data which is reused with the variable printing, and is data used between records as shared image data and so forth. The reusable data to be used is specified according to the reference instructions of the reusable data.

In step S302, the variable data analysis unit 113 temporarily determines the record segments, based on repeated reference instruction of the reusable data with the PPML data. That is to say, the variable data analysis unit 113 determines the boundary candidates of the records, based on the reference cycle of reusable data.

In step S303, the variable data analysis unit 113 determines whether or not the temporary determining of record segments could have been made in step S302. In the case that temporary determining of record segments could not be made, the flow is advanced to step S309, and the variable data analysis unit 113 turns off the analysis success flag, and the record dividing processing is ended.

On the other hand, in the case that record segments can be temporary determined, the flow is advanced to step S304, and the variable data analysis unit 113 detects the variable data within the record segments temporarily determines. The variable data here is data which differs for each record with variable printing.

In step S305, the variable data analysis unit 113 determines whether the variable data arrangement repeat pattern is appropriate or not. Specifically, the variable data analysis unit 113 determines whether or not the variable data type for each page range divided according to the record segments temporarily determined and the drawing positions thereof is the same. That is to say, the variable data analysis unit 113 determines whether or not the variable data type for each corresponding page and the drawing positions thereof are the same within the ranges segmented with the segments temporarily determined for the print job.

Consequently, in the case determination is made that the variable data arrangement repeat pattern is not appropriate, the flow is advanced to step S310, and the variable data analysis unit 113 again temporarily determines the record segments from the variable data arrangement repeat pattern, and the flow is returned to step S303. On the other hand, in the case determination is made that the variable data arrangement repeat pattern is appropriate, the flow is advanced to step S306 with the temporarily determined record segments as the boundaries of the records.

In step S306, the variable data analysis unit 113 records record information (number of pages and information relating to the variable data and so forth) in the job-record recording unit 115. Next, in step S307, the variable data analysis unit determines whether there is a subsequent record, i.e. whether there are any records which have not ended processing. As a result of the determination, in the case there is a subsequent record (unprocessed record), the flow is returned to step S304, and in the case there is not a subsequent record, the flow is advanced to step S308.

In step S308, the variable data analysis unit 113 turns the analysis success flag on and ends the record dividing processing. Note that the analysis success flag is used to determine whether or not the record dividing has successes in step S105 in FIG. 11.

FIG. 15 is a flowchart showing the executed job updating processing in step Sill as shown in FIG. 11.

In step S401, the job management application 92 obtains the range wherein the record operation is executed as to the print job by the operator or the like. In step S402, the job management application 92 determines whether the last page number within the range wherein the record operation is performed is smaller than the page number already subjected to RIP processing with the color MFP 26.

As a result of the determination is step S402, in the case that the last page number relating to the record operation is smaller than the page number subjected to RIP processing, the flow is advanced to step S403. In step S403, the job management application 92 converts the instruction information of the record operation (operation content) to page number operation instruction information, more specifically, instruction information for the printing page range corresponding to the record subject to operation. In step S404, the information is sent to the color MFP 26 as operation instruction information by page number rather than as operation instruction information of a record.

On the other hand, in the case that determination is made in step S402 that the last page number relating to record operations is not smaller than the page number subjected to RIP processing, the flow is advanced to step S405. In step S405, the job management application 92 executes processing relating to record data including the page before RIP processing (pre-RIP data operation processing).

FIG. 16 is a flowchart showing the pre-RIP data operation processing in step S405 as shown in FIG. 15.

In step S501, the job management application 92 determines the leading page number within the range wherein the record operation is performed. Also, in step S502, the job management application 92 obtains the last page number subjected to RIP processing in advance for improved printing performance with the MFP, and the page number subjected to printing processing, from the color MFP 26.

In step S503, the job management application 92 determines whether the leading page number within the range wherein the record operation is performed is smaller than the last page number subjected to RIP processing of the color MFP 26. As a result of the determination, in the case the leading page number relating to the record operation is smaller than the last page number subjected to RIP processing, we can understand that there is a page subjected to RIP processing within the range of the record operation, and in the case the leading page number relating to the record operation is not smaller, the operated record is all pages before RIP processing.

In step S504, the job management application 92 sends the instruction information relating to data subjected to RIP processing, similar to the example in the flowchart shown in FIG. 15.

Next, in step S505, currently the pages subjected to printing with the color MFP 26 have ended the printing, so a description that the page has finished printing is provided to the variable data. For example, a processed mark can be set in the JDF data referenced from the PPML. In step S506, the changed variable data is sent to the color MFP 26, and re-setting processing for the variable job recorded in the color MFP is performed.

Hereafter, the operations in record increments as to a printing job according to the present embodiment will be described centering around the description of the operating screen relating to the job management application 92.

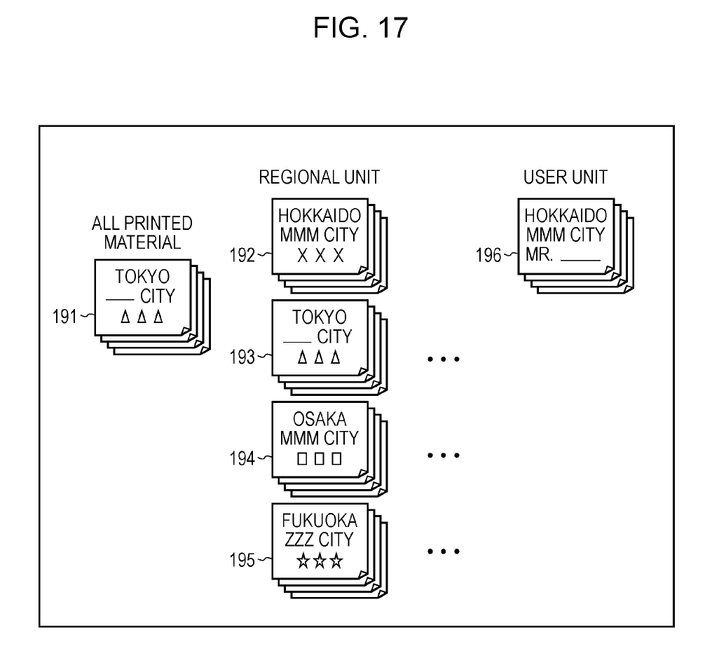

FIG. 17 is a diagram for describing an example of a variable printing print job according to the present embodiment. With the example shown in FIG. 17, an example is shown of a variable printing print job in the case of a certain company send direct mail to customers, for example. In FIG. 17, reference numeral 191 denotes all of the printed material with variable printing. The reference numerals 192, 193, 194, and 195 denote data segments for regions such as Hokkaido and Tokyo in the variable printing print job. In this example, a reusable object is used for location information of an office by region. Reference numeral 196 denotes direct mail to a customer which is managed by an employee associated with the Hokkaido office. With the present embodiment, information showing an access method to the employee is used with a reusable object for each employee.

FIG. 18 is a diagram for describing a dialog screen of the job management application 92. The dialog screen shown in FIG. 18 corresponds to the case wherein the Hokkaido/Tokyo/Osaka regions of the variable printing print job shown in FIG. 17 are printed, and the job name is displayed as catalog.

In FIG. 18, reference numeral 200 denotes a dialog when the job management application 92 is displayed on the screen. Reference numerals 201A, 201B, and 201C each denote a job, and the catalog job 201B is a job corresponding to that shown in FIG. 17. Reference numerals 202, 203, 204, 205, 206, 207, and 208 each denote a record for a catalog job. With the present embodiment, the records 202 through 204 denote a record for the Hokkaido region with the example shown in FIG. 17, the records 205 and 206 denote a record for the Tokyo region, and the records 207 and 208 denote a record for the Osaka region. With the dialog screen in the job management application 92, a list of print jobs and the records making up such jobs are displayed, and in addition to the relation of the print jobs and records, the print status information for each job and for each record and the number of pages for each record are also displayed together.

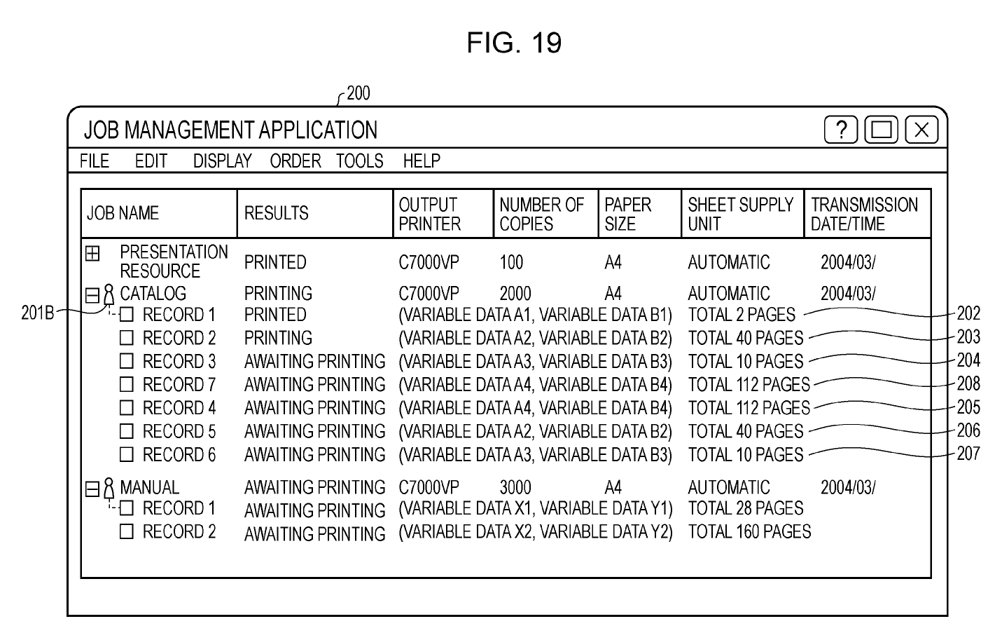

FIG. 19 shows an example wherein the printing sequence of records as an operation relating to printing control are changed as to the catalog/variable job 201B with the example shown in FIG. 18. In FIG. 19, the components which are the same as the components shown in FIG. 18 have the same reference numerals thereto. In the example shown in FIG. 19, an operation is performed to move the record 208 between the record 204 and record 205 as to the print job 201B in the example shown in FIG. 18, and the record 208 is moved after the record 204. The processing in this case can be realized with processing operations shown in the flowchart in FIG. 11.

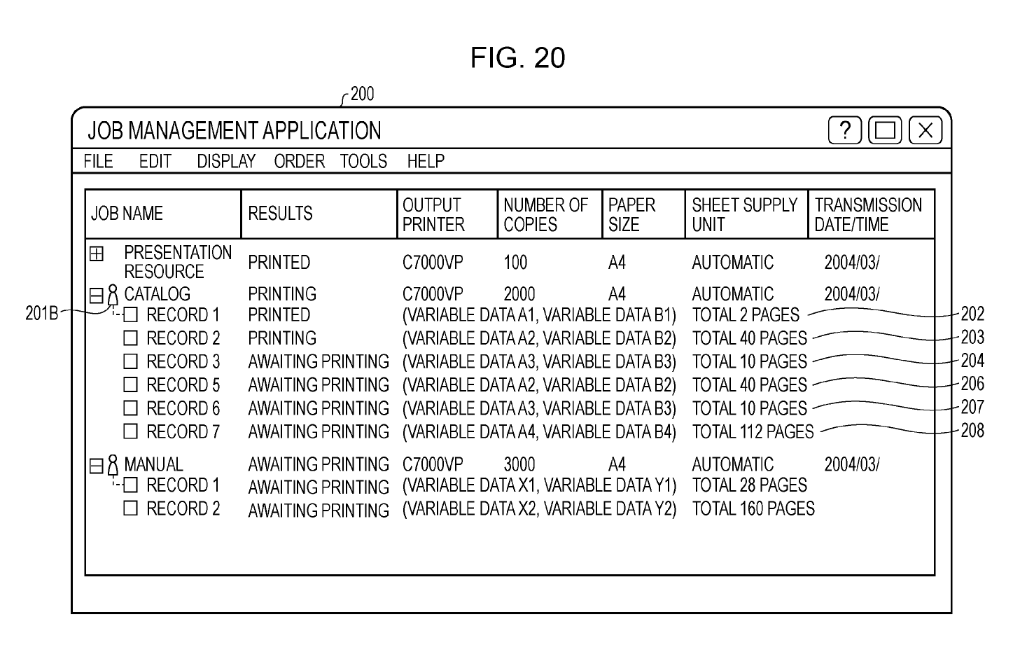

FIG. 20 shows an example wherein hold processing of records as an operation relating to printing control is performed as to the catalog/variable job 201B with the example shown in FIG. 18. In FIG. 20, the components which are the same as the components shown in FIG. 18 have been denoted with the same reference numerals. With the example shown in FIG. 20, an operation to specify holding the record 205 is performed with the example shown in FIG. 18, and the record 205 is not displayed on the dialog screen 200 of the job management application showing information of during printing processing. Note that it goes without saying that information of a record specifying holding can be displayed on a dialog screen of a job management application, but the description thereof is omitted with the present embodiment. The processing in this case also can be realized with processing operations shown in the flowchart in FIG. 11.

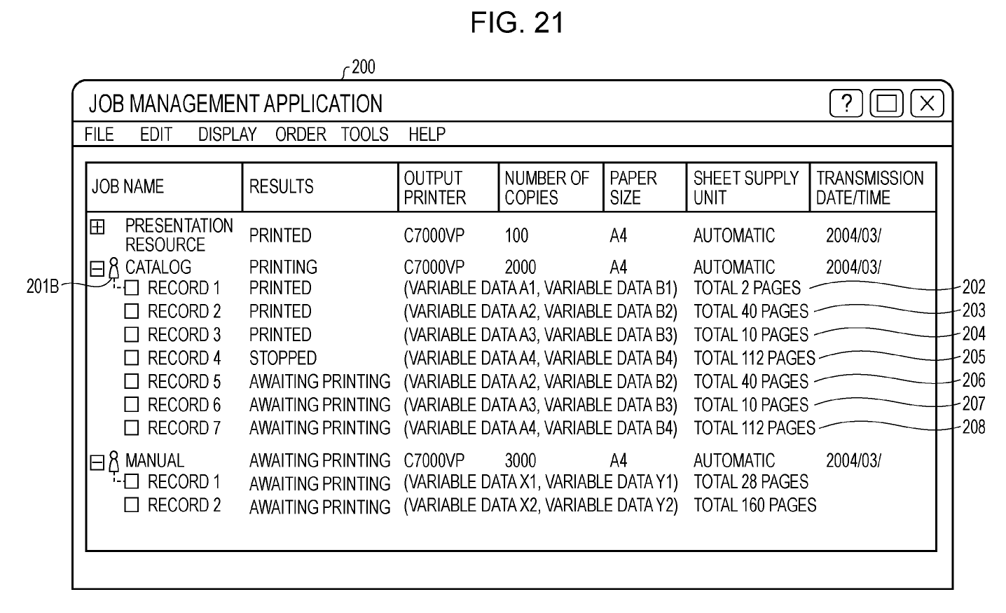

FIG. 21 shows an example wherein pausing processing of records as an operation relating to printing control is performed as to the catalog/variable job 201B with the example shown in FIG. 18. In FIG. 21, the components which are the same as the components shown in FIG. 18 have been denoted with the same reference numerals. With the example shown in FIG. 21, an operation to specify pausing the record 205 is performed with the example shown in FIG. 18, and the record 205 is displayed as paused on the dialog screen 200 of the job management application showing information of during printing processing. The processing in this case also can be realized with processing operations shown in the flowchart in FIG. 11.

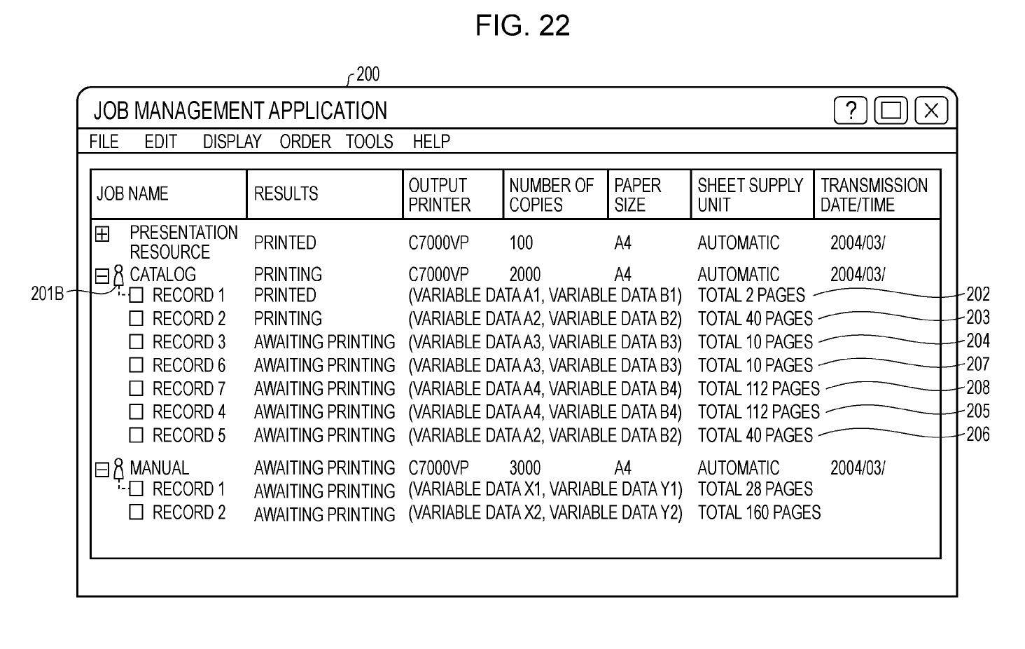

FIGS. 22 through 26 are diagrams for describing another example in the case of performing record operations as to a variable printing print job. The example shown in FIGS. 22 through 26 groups the records included in the reference range of the reusable object, and performs operations relating to printing controls such as sequence change or specifying a hold or specifying pausing in group increments (in a record group made up of records belonging to a group). Note that in FIGS. 22, 23, and 26, the components which are the same as the components shown in FIG. 18 have been denoted with the same reference numerals.

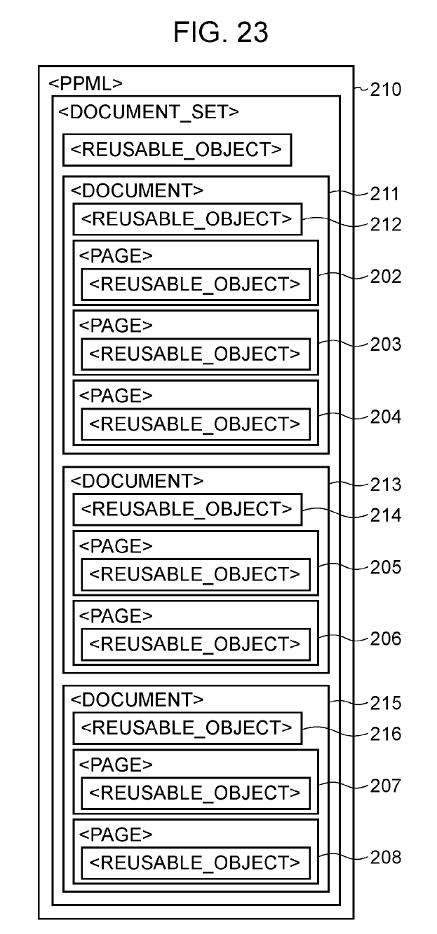

FIG. 22 shows an example wherein the printing sequence of records as an operation relating to printing control are changed as to the catalog/variable job 201B with the example shown in FIG. 18. With the example shown in Fig. 22, let us say that instructions (operations) are made so as to move the record 208 before the record 205. In this case, this differs from the example shown in FIG. 19, and the records 207 and 208 are moved after the record 204. The processing in this case is described with reference to Figs. 23 through 25.

FIG. 23 is a diagram showing PPML data configuration of the catalog job 201B in FIG. 22. In FIG. 23, reference numeral 210 denotes all of the PPML data. Reference numeral 211 denotes all of the records for the Hokkaido region, and records 202, 203, and 204 show that the information for the Hokkaido office is held as a shared reusable object 212. Also, reference numeral 213 denotes all of the records for the Tokyo region, and records 205 and 206 show that the information for the Tokyo office is held as a shared reusable object 214. Reference numeral 215 denotes all of the records for the Osaka region, and records 207 and 208 show that the information for the Osaka office is held as a shared reusable object 216.

With the present embodiment, an operation is performed to move the record 208 before the record 205. At this time, with the present embodiment, the records 205 and 206 use the same reusable object, so determination is made to not separate the records 205 and 206 as one record group. Also, the records 207 and 208 use the same reusable object, so determination is made to move the records 207 and 208 together as one record group. Consequently, as shown in FIG. 22, the printing sequence of the records 205 and 206 are changed to be later together, and the records 207 and 208 are moved together.

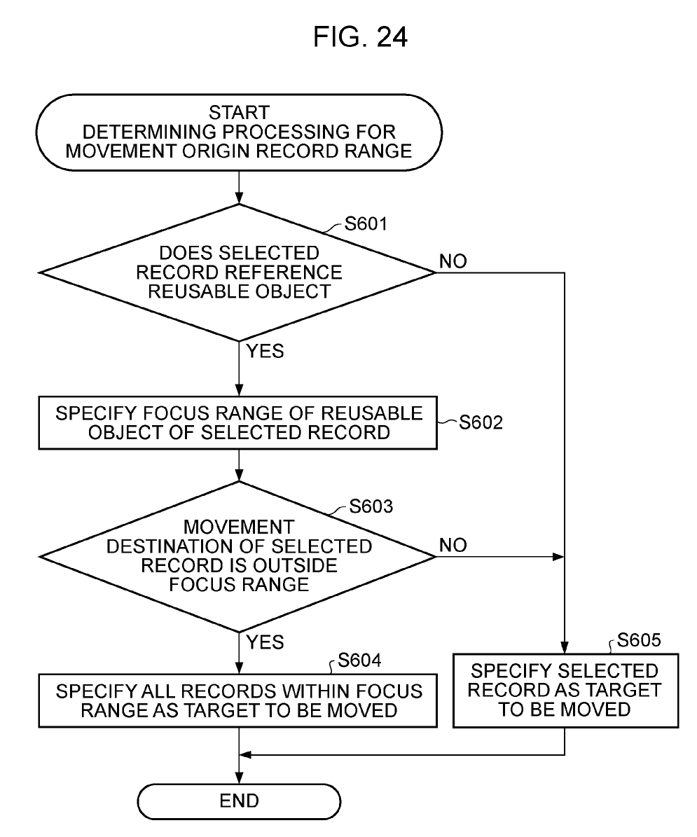

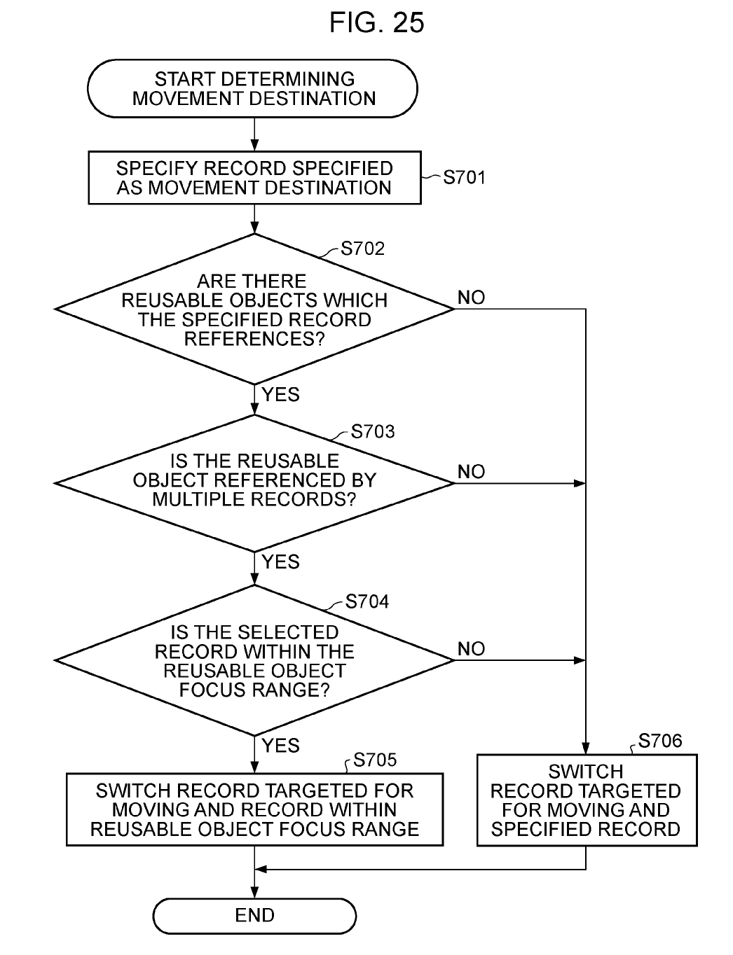

FIGS. 24 and 25 are flowcharts showing the moving processing of the records as shown in FIG. 22. FIG. 24 shows the flow of processing to determine the record range at the movement origin (movement origin record range determining processing).

First, in step S601, the job management application 92 determines whether or not the selected record references the reusable object list. With the example shown in FIG. 22, record 208 is selected, and the record 208 references the reusable object 216, so step S601 is determined as YES.

In step S602, the job management application 92 specifies a focus range of the reusable object list for the selected record. Specifically, a record which references the reusable object is specified. In FIG. 23, the records 207 and 208 which reference the reusable object 216 are specified as the focus range.

In step S603, the job management application 92 determines whether or not the movement destination for the selected record is outside of the focus range. In the case determination is made in step S603 that the movement destination for the selected record is outside of the focus range, the job management application 92 specifies all of the records within the focus range as subject to moving (S604). Specifically, in the case determination is made that the movement destination of the record 208 is outside the focus range 215, the records 207 and 208 are specified as subject to moving.

On the other hand, in step S603, if the movement destination of the selected record is within the focus range, the job management application 92 specifies the selected record as subject to moving (S605).

FIG. 25 shows the flow of the processing determining the record position at the movement destination (movement destination record position determining processing).

In step S701, the job management application 92 specifies the record specified as the movement destination. For example, in the case that the selected record is moved on top of another record using drag-and-drop, the separate record is specified as the movement destination.

In step S702, the job management application 92 determines whether or not the record specified in step S701 references the reusable object.

In step S702, in the case determination is made that there is a reusable object to reference, the job management application 92 determines whether or not the reusable object is referenced from multiple records (S703). Specifically, the determining processing in step S703 is realized by the job management application 92 counting the number of records referencing the reusable object.

In step S704, the job management application 92 determines whether or not the record selected for moving is within the focus range of the reusable object. For example, in FIG. 22, in the case that the record 7 is moved on top of the record 4 using drag-and-drop, the refutable object 214 which the record 4 references is specified. Subsequently, by determining whether or not the selected record 7 references the reusable object 214, the determining processing in step S704 is realized.

In the case that YES is determined in step S704, the job management application 92 switches the record subject to moving which is specified in FIG. 24 and the record in the focus range of the reusable object determined in step S702 (S705). Specifically, this corresponds to the processing in FIG. 23 to switch the records 207 and 208 with the records 205 and 206.

On the other hand, in the case NO is determined in any one of steps S702 through S704, the job management application 92 switches the records subject to moving which are specified in FIG. 23 and the records specified in step S701 (S706).

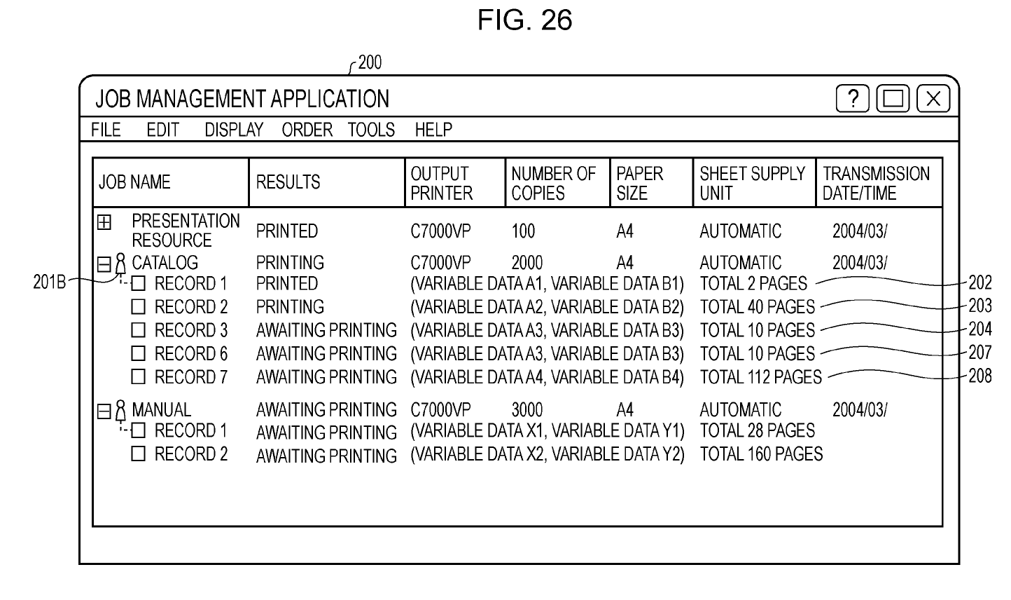

FIG. 26 shows another example of a record hold processing performed as to the catalog/variable job 201B with the example shown in FIG. 18. With the example shown in FIG. 26, let us say that an operation is performed to specify holding of the record 205 with the example shown in FIG. 18. In this case, this differs from the example shown in FIG. 20, the records 205 and 206 which use the same reusable object are moved into a hold queue, and are no longer displayed on the dialog screen 200 of the job management application 92.

Note that as with to the record operation for pausing specifying, in the case that pausing is specified for a certain record, an arrangement may be made wherein pausing processing is performed with records using the same reusable object as a set.

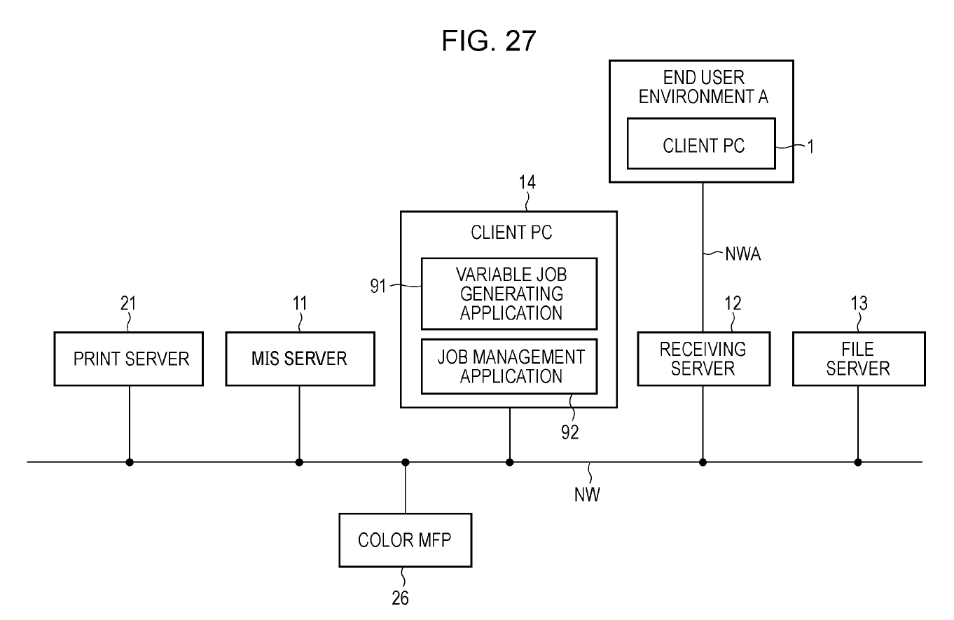

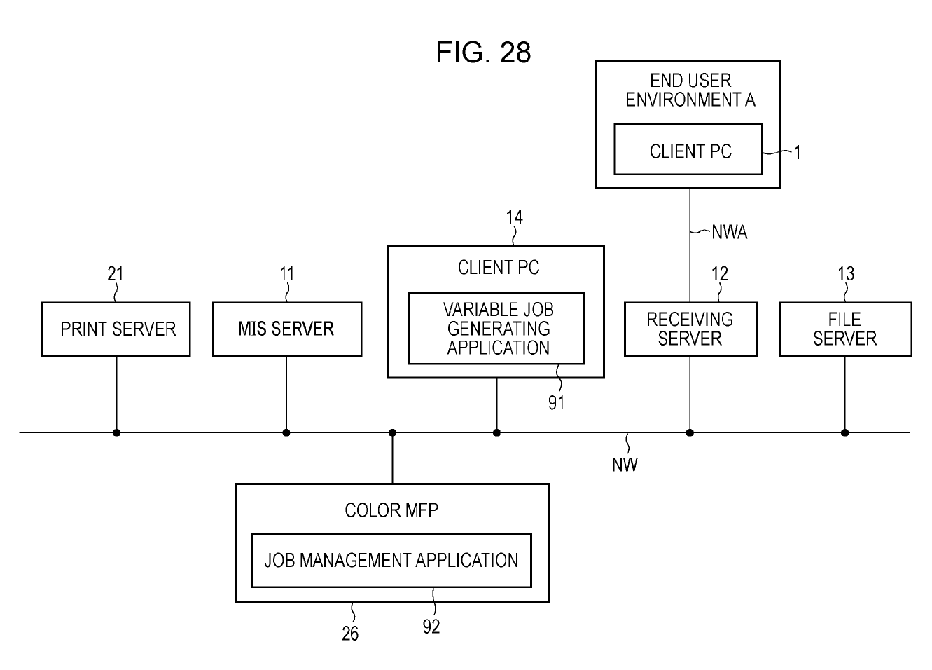

Note that with the above-described present embodiment, an example is described of a case wherein a print server 21 has a job management application 92, but the present invention should not be limited to this. For example, as shown in FIG. 27, an arrangement may be made wherein the client PC 14 has a job management application 92 in addition to the variable job generating application 91. Also, for example, as shown in FIG. 28, an arrangement may be made wherein the job management application 92 is provided on the image forming apparatus such as color MFP 26.

Thus, according to the present embodiment as described above, record segments of a print job made up of multiple records are detected and the print job is divided into increments of records, and each record and the corresponding printing page thereto are correlated and managed. As shown in FIG. 18 and so forth, the print job and the records making up such print job are displayed as a list including status information and so forth in increments of print job and each record. Thus, the status of each record of the variable printing print job can be readily recognized, and for example how much of the printing processing of the print job has finished, or which record has finished printing processing and so forth can be determined, enabling management readily.

Also, by performing operation instruction relating to the print control as to the record in the displayed list, processing can be performed in increments of records. For example, in the case of executing processing based on operating instructions as to a portion of records, there is no need to cancel the entire print job and perform printing instructions again as has been the case conventionally. Accordingly, in the event of executing a variable printing print job, operations can be performed relating to printing control (job editing such as printing sequence and deleting) by controlling and managing in increments of records, so that the performance of the printing processing is not reduced, whereby work efficiency can be improved.

According to the present invention, record segments of the print job made up of multiple records are detected, and processing according to the operation instructions input in increments of records is executed as to the records, whereby control management can be performed in increments of records of the print job made up of multiple records.

### Other Embodiments of the Present Invention

A software program for realizing functions of the above-mentioned embodiments is supplied to a computer (CPU or MPU) in a device connected to other types of devices or within a system, so as to operate various types of devices to realize the functions of the above-described embodiment. Operating the various types of devices according to the program stored in the computer of such system or device to realize the functions of the above-described embodiment is also included in the scope of the present invention.

Also, in this case, the program itself of the software realizes the functions of the above-described embodiment, and the program itself makes up the present invention. Also, an arrangement for supplying the program to a computer, e.g. a recording medium storing such program makes up the present invention. As a recording medium to store such program, for example a flexible disk, hard disk, optical disk such as CD-ROM, magneto-optical disk, magnetic tape, non-volatile memory card, ROM, and so forth may be employed.

Also, it goes without saying that in the case that the supplied program cooperates with an operating system or other application software which operates on a computer to realize the functions of the above-described embodiment, the program is included in an embodiment of the present invention.

Further, upon a supplied program being stored in memory attached to a function expansion board or function expansion unit provided to the computer, the CPU or the like of the function expansion board or the like may perform a portion or all of the actual processing based on the instructions of such program. It goes without saying that in the case that the functions of the above-described embodiment are realized by such processing, this is included in the present invention also.

Note that each of the above-described embodiments only show an example of specifics in carrying out the present invention, and the technical scope of the present invention is not to be interpreted as being restricted thereby. That is to say, the present invention can be carried out in various forms without departing from the technical essence and primary features thereof.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Application No. 2007-218811 filed Aug. 24, 2007, which is hereby incorporated by reference herein in its entirety.

What is claimed is:

1. An information processing apparatus comprising:
an analysis unit configured to analyze a print job made up of a plurality of records;
a processing unit configured to detect segments of a record using the analyzed print job and correspond each record with a printing page corresponding to each record;
a display control unit configured to display a list of records based on the detected segments; and
an operating unit configured to execute processing, upon operating instructions being input for printing control as to records in the displayed list, based on the operating instructions as to records specified in accordance with the operating instructions.

2. The information processing apparatus according to claim 1, wherein the operating instructions include at least one of changing, deleting, and pausing of a printing sequence.

3. The information processing apparatus according to claim 1, wherein the operating unit converts operating instruction information as to the records into instruction information for a corresponding printing page range in accordance with a correlation between each record and printing page with the processing unit, and outputs this to an image forming apparatus which performs processing according to the print job.

4. The information processing apparatus according to claim 1, wherein the operating unit processes a record group included in a reference range of reusable objects relating to the records instructed according to the operating instructions.

5. The information processing apparatus according to claim 1, wherein the processing unit detects the segments of the records based on the reference instructions of reusable objects and drawing positions of variable data in the print job.

6. The information processing apparatus according to claim 5, wherein the processing unit temporarily determines the segments of the records based on repeats of reference instructions of the reusable objects, and between temporarily determined ranges detects the temporarily determined segments of the records as the segments of the records if the drawing positions of the variable data are the same for each corresponding page.

7. An information processing apparatus comprising:
an analysis unit configured to analyze record configuration of a print job;
a dividing unit configured to divide the print job into records according to analysis results of the analysis unit;
a management unit configured to associate and manage the print job and divided records;
an operation control unit configured to instruct printing control operation as to the records managed by the management unit;
an operation analysis unit configured to analyze instructions from the operation control unit; and
a notifying unit configured to notify operating content obtained from the operation analysis unit to an image forming apparatus that performs print processing according to the print job.

8. The information processing apparatus according to claim 7, further comprising:
a management information updating unit configured to update information managed by the management unit, based on results analyzed by the operation analysis unit; and
an updating unit configured to reflect updated results from the management information updating unit on the print job of the image forming apparatus.

9. The information processing apparatus according to claim 7, wherein the operation control unit instructs at least one operation of changing a sequence of the print processing, pausing the print processing, and deleting print processing in increments of records.

10. The information processing apparatus according to claim 7, wherein the operation analysis unit determines a group of records using reusable objects;
and wherein at least one operation of changing a sequence of the print processing, pausing the print processing, and deleting print processing can be performed in increments of the groups.

11. The information processing apparatus according to claim 7, further comprising:
a display control unit configured to display a relationship between the print job and records recorded in the management unit on a display unit.

12. An information processing method comprising:
analyzing a print job made up of a plurality of records;
detecting segments of a record using analysis results and correspond each record with a printing page corresponding to each record;
displaying a list of records based on detection results; and
processing, upon operating instructions being input for printing control as to records in the displayed list, based on the operating instructions as to records specified in accordance with the operating instructions.

13. A computer-readable medium storing instructions causing an apparatus to perform the method comprising:
analyzing a print job made up of a plurality of records;
detecting segments of a record using analysis results and correspond each record with a printing page corresponding to each record;
displaying a list of records based on detection results; and
processing, upon operating instructions being input for printing control as to records in the displayed list, based on the operating instructions as to records specified in accordance with the operating instructions.

14. An information processing apparatus comprising:
a detecting unit configured to detect segments of a record by using a reference instruction of reusable object which is included in the print job having a plurality of records;
a specifying unit configured to specify page corresponding to each record obtained by using the detecting result of said detecting unit; and
a display control unit configured to display a printing status of the each record by using a printing result of the print job.

15. An information processing method comprising:
detecting segments of a record by using a reference instruction of reusable object which is included in the print job having a plurality of records;
specifying page corresponding to each record obtained by using detecting result; and
displaying a printing status of the each record by using a printing result of the print job.

16. A computer-readable medium storing instructions causing an apparatus to perform the method:
detecting segments of a record by using a reference instruction of reusable object which is included in the print job having a plurality of records;
specifying page corresponding to each record obtained by using detecting result; and
displaying a printing status of the each record by using a printing result of the print job.
